(19) United States
(12) Patent Application Publication
(10) Pub. No.: US 2011/0299427 A1
(43) Pub. Date: Dec. 8, 2011

(54) METHOD AND APPARATUS FOR DISTRIBUTED MEDIA CONFERENCING

(76) Inventors: Thomas P Chu, Englishtown, NJ (US); Ramesh Nagarajan, Princeton Junction, NJ (US)

(21) Appl. No.: 13/202,790

(22) PCT Filed: Apr. 14, 2009
(86) PCT No.: PCT/US09/40471

§ 371 Date: Aug. 23, 2011

(51) Int. Cl. H04L 12/44

(52) U.S. Cl. 370/256

(57) ABSTRACT

A capability for determining a media distribution tree for use in distributing content to a plurality of user devices is provided. Using the distributed content distribution capability, one or more of the user devices to which the content is to be distributed functions as a relay point that performs content replication and distribution functions for one or more other user devices. The content is distributed using a media distribution tree into which the user devices are arranged. A method for determining a media distribution tree for use in distributing content to a plurality of user devices includes grouping the user devices into a plurality of regions, determining, for each of the regions, a regional tree to be formed by the user devices grouped into the region, and connecting the regional trees to determine thereby the media distribution tree. By utilizing user devices as relay points within the media distribution tree, usage of network resources, such as ports at media servers, is significantly reduced.

### FIELD OF THE INVENTION

The invention relates to the field of conferencing and, more specifically, to establishment and management of conferences.

### BACKGROUND OF THE INVENTION

The popularity of multimedia conferences continues to grow. This increase in popularity is due to a number of factors. First, the processing power of work stations and personal computers has increased to the point that such devices readily can handle video encoding/decoding, in addition to audio and data encoding/decoding. Second, video cameras supporting standard interfaces, e.g., USB, to personal computers are readily available. Finally, broadband network access required to participate in such conferences over networks is readily available. Disadvantageously, however, existing media conferences consume a significant amount of resources of both the media server facilitating the media conference and the underlying transport network conveying media content for the media conference.

### SUMMARY OF THE INVENTION

Various deficiencies in the prior art are addressed by a method, apparatus, and computer-readable medium for providing a distributed content distribution capability for enabling distribution of content to user devices.

Using the distributed content distribution capability, one or more of the user devices, to which the content is to be distributed, functions as a relay point that performs content replication and distribution functions for one or more other user devices. The content is distributed using a media distribution tree into which the user devices are arranged. By utilizing user devices as relay points within the media distribution tree, usage of network resources, such as ports at media servers, is significantly reduced.

A method for determining a media distribution tree for use in distributing content to a plurality of user devices includes grouping the user devices into a plurality of regions, determining, for each of the regions, a regional tree to be formed by the user devices grouped into the region, and connecting the regional trees to determine thereby the media distribution tree. The user devices may be grouped into regions based on geographic locations of the user devices, thereby enabling significant reductions in network bandwidth usage where user devices relatively close to each other geographically are grouped into the same region. The user devices also may be grouped into regions using other information associated with the user devices, e.g., in place of using geographic location information and/or in addition to using geographic location information.

The media distribution tree may be determined for a conference between the user devices, as well as for other applications in which content is distributed to user devices.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an exemplary conference media distribution tree;

FIG. 2 depicts an exemplary embodiment of a method for establishing a conference media distribution tree;

FIG. 3 depicts an exemplary embodiment of a method for determining a media distribution tree;

FIG. 4 depicts an exemplary embodiment of a method for determining a regional tree for conference participant nodes grouped into a region;

FIG. 5A depicts an example illustrating the manner in which a regional tree is updated to include a conference participant node that is not capable of replicating and distributing any media streams;

FIG. 5B depicts an example illustrating the manner in which a regional tree is updated to include a conference participant node that is capable of replicating and distributing one or more media streams;

FIG. 6 depicts an exemplary embodiment of a method for updating a regional tree when a conference participant node leaves an existing media distribution tree;

FIG. 7 depicts an example illustrating the manner in which a regional tree is updated in response to a conference participant node leaving the media distribution tree;

FIG. 8 depicts an exemplary embodiment of a method for forming a media distribution tree by interconnecting regional trees;

FIG. 9 depicts an exemplary embodiment of a method for determining a distance of an unattached region to a backbone tree;

FIG. 10 depicts an example illustrating formation of a media distribution tree by interconnecting regional trees;

FIG. 11A depicts an exemplary portion of a media distribution tree without a bypass connection;

FIG. 11B depicts an exemplary portion of a media distribution tree with a bypass connection;

FIG. 12 depicts a high-level block diagram of functional components of an exemplary conferencing system; and

FIG. 13 depicts a high-level block diagram of a general-purpose computer suitable for use in performing functions described herein.

To facilitate understanding, identical reference numerals have been used, where possible, to designate identical elements that are common to the figures.

### DETAILED DESCRIPTION OF THE INVENTION

A distributed conferencing capability is depicted and described herein. The distributed conferencing capability enables establishment of a media distribution network by which content may be distributed to user devices participating in a conference. The distributed conferencing capability uses user devices participating in the conference to relay content between user devices of the media distribution network, thereby reducing equipment costs and network costs. The media distribution network is established using a tree topology, denoted as a media distribution tree. The media distribution tree specifies the topology of the media distribution network by which content is distributed to the user devices. The media distribution tree is determined by processing information associated with the user devices, such as geographic locations of the user devices, device capabilities of the user devices (e.g., device connectivity, device processing power, and the like), and the like, as well as various combinations thereof. The media distribution tree may be determined using various other types of information. The manner in which a media distribution tree may be determined is described in detail hereinbelow.

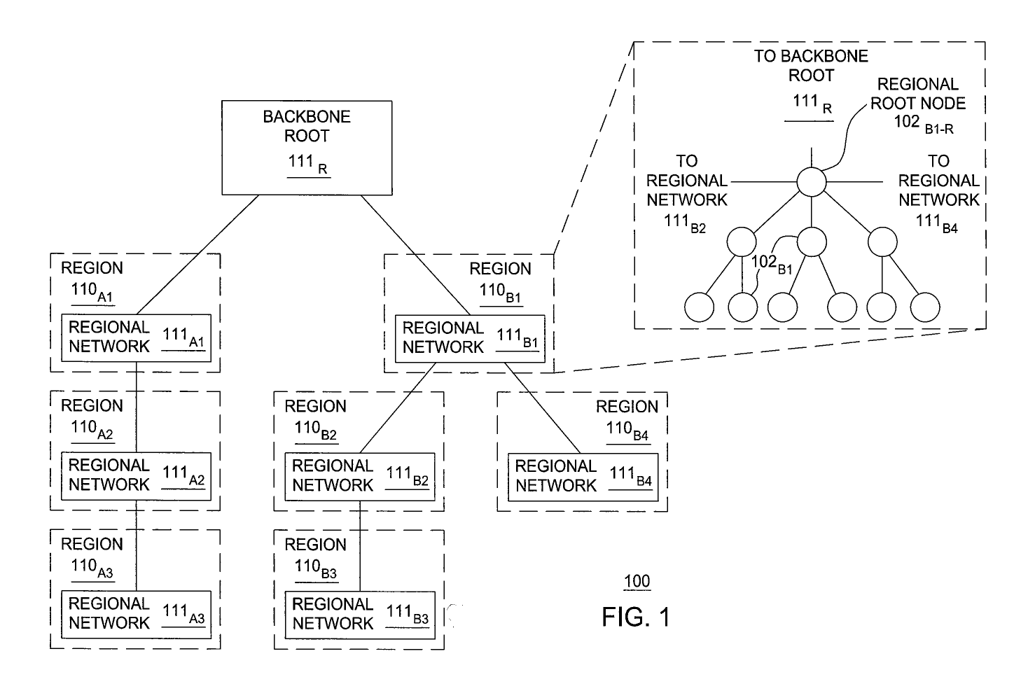

FIG. 1 depicts a high-level block diagram of an exemplary conference media distribution tree.

As depicted in FIG. 1, conference media distribution tree 100 includes a plurality of regions 110_{A1}-110_{A3} (collectively, regions 110_{A}) and a plurality of regions 110_{B1}-110_{B4} (collectively, regions 110_{B}). The regions 110A and 110B are interconnected to form a backbone tree of regions rooted at a backbone root 111_{R}. The regions 110_{A} and regions 110_{B} may be referred to collectively as regions 110.

The backbone root 110_{R} functions as the root of the conference media distribution tree 100. The backbone root 110_{R} may be a media conference server, multiple media conference servers networked to form a backbone root network, a conference participant device, multiple conference participant devices networked to form a backbone root network, and the like, as well as various combinations thereof.

As depicted in FIG. 1, each of the regions 110 includes a plurality of conference participant nodes 102 (collectively, conference participant nodes 102, or, more generally, nodes 102), respectively. The nodes 102 of a region 110 are organized to form a regional network 111. A regional network 111 is organized as a regional tree having a regional root node (denoted as regional root node, 102_{x-R}). The backbone root 111_{R} and regional root nodes 102_{x-R} are interconnected, thereby forming conference media distribution tree 100.

FIG. 1 depicts details of one of the regions 110 (illustratively, region 110_{B1}). The exemplary region 110_{B1} includes a plurality of nodes 102_{B1} which are organized to form an exemplary regional network 111_{B1}. The exemplary regional network 111_{B1} includes a network of conference participant nodes 102_{B1} organized as a regional tree rooted at a regional root node denoted as 102_{B1-R}. The regional network 111_{B1} is connected to backbone root 111_{R}, regional network 110_{B2}, and regional network 110_{B4} by interconnecting the regional root node 102_{B1-R} to backbone root 111_{R}, to a regional root node 102_{B2-R} of regional network 110_{C2} (not depicted), and to a regional root node 102_{B4-R} of regional network 110_{C4} (also not depicted).

As depicted in FIG. 1, the conference media distribution tree 100 is organized such that regional network 111_{A1} and regional network 111_{B1} are children of backbone root 111_{R}, regional network 111_{A2} is a child of regional network 111_{A1}, regional network 111_{A3} is a child of regional network 111_{A2}, regional network 111_{B2} is a child of regional network 111_{B1}, regional network 111_{B3} is a child of regional network 111_{B2}, and regional network 111_{B4} is a child of regional network 111_{B1}.

The conference media distribution tree 100 provides interconnectivity between all conference participant nodes 102 participating in the conference.

The conference participant nodes 102 may include any nodes capable of participating in a conference, such as computers, PDAs, phones, and the like. The conference participant nodes 102 may include built-in capabilities, peripheral devices, and the like, as well as various combinations thereof, which may be useful for conferencing, such as microphones, video cameras, video displays, whiteboard capabilities, and the like, as well as various combinations thereof. The conference participant nodes 102 also may be referred to more generally herein as user devices or nodes, given that the distributed conferencing capability depicted and described herein may be utilized in non-conferencing applications.

The conference participant nodes 102 may access the conference using any suitable network access technology, such as cable, digital subscriber line (DSL), fiber-to-the-home (FTTH), wireless access, and like suitable network access technologies, as well as various combinations thereof.

The conference participant nodes 102 may communicate, within the regional networks 111 and between the regional networks 111, using any suitable underlying communications technologies. For example, conference participant nodes 102 may communicate using IP-based communications or other suitable communications technologies, and the like, as well as various combinations thereof.

The conference media distribution tree 100, once established in the network, controls the distribution of content between conference participant nodes 102.

As an example, assume that one of the conference participant nodes 102 of regional network 111_{A2} is providing a multimedia stream to each of the other conference participant nodes. In this example, the multimedia stream is propagated within regional network 111_{A2} toward leaves of the regional tree and toward the regional root node 102_{A2-R} of regional network 111_{A2}. The multimedia stream also is propagated from the regional root node 102_{A2-R} of regional network 111_{A2} toward regional root nodes 102_{A3-R} of regional network 111_{A3}and 102_{A1-R} of regional network 111_{A1}. The multimedia content continues to be propagated within and between regional networks 111 until each of the conference participants has received the media content. A person skilled in the art will understand the manner in which media streams are propagated over a media distribution tree.

The content which may be distributed via a conference media distribution tree may include any content, such as audio, text, images, video, multimedia, and like content, as well as various combinations thereof. As such, although primarily depicted and described herein with respect to specific types of media content, it will be appreciated that any content may be distributed via a media distribution tree established using the distributed conferencing capability depicted and described herein.

The content may be distributed via a conference media distribution tree using any suitable content propagation protocols (e.g., using the Real-Time Transport Protocol (RTP) or any other suitable content propagation protocols, as well as various combinations thereof. Thus, although primarily depicted and described herein with respect to specific to specific technologies which may be utilized to facilitate content propagation, it will be appreciated that any content propagation capabilities may be utilized to propagate content via a conference media distribution tree established using the distributed conferencing capability depicted and described herein.

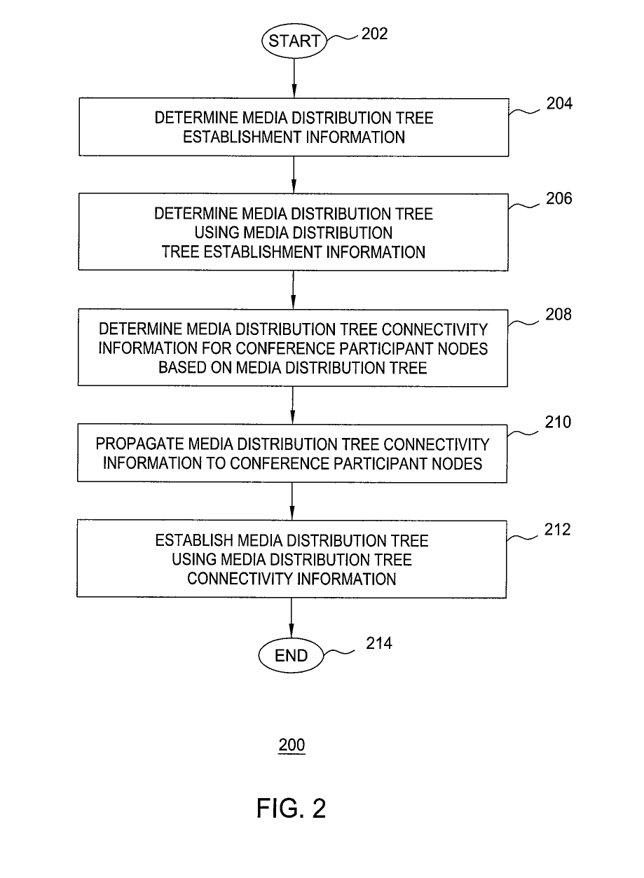

A method, according to one embodiment, for establishing a conference media distribution tree, such as exemplary conference media distribution tree 100 of FIG. 1, is depicted and described with respect to FIG. 2.

FIG. 2 depicts an exemplary embodiment of a method for establishing a conference media distribution tree.

Although primarily depicted and described herein as being performed serially, at least a portion of the steps of method 200 may be performed contemporaneously, or in a different order than depicted and described with respect to FIG. 2.

Although primarily depicted and described herein with respect to an embodiment in which method 200 is executed by a conference management server, it will be appreciated that the method 200 may be executed by any suitable functional element or combination of functional elements. For example, method 200 may be implemented in a centralized fashion (e.g., by a media server that is functioning as a root of the conference media distribution tree, by a conference participant node that is functioning as a root of the conference media distribution tree, by a management system, and the like) and/or in a distributed fashion (e.g., where the steps of method 200 are distributed across multiple participants, multiple media servers, multiple management systems, and the like, as well as various combinations thereof).

At step 202, method 200 begins.

At step 204, media distribution tree establishment information is determined.

The media distribution tree establishment information may include any information which may be used to establish the media distribution tree, which may include information for use in determining the media distribution tree topology, information for use in configuring connectivity between conference participant nodes to establish the media distribution tree, and the like, as well as various combinations thereof.

In one embodiment, media distribution tree establishment information includes, for each conference participant node that is to be included in the media distribution tree, location information associated with the node, device capability information for the node, media content communication information for the node, and the like, as well as various combinations thereof.

The location information associated with a conference participant node may include a geographic location of the node, a network location of the node, and the like. The location information associated with conference participants may be used in order to group conference participant nodes into regions, as described in additional detail hereinbelow.

The geographic location of a node may be specified in any suitable format. The geographic location of a node may be determined using any suitable information, such as GPS information, postal address of a user(s) of the node, postal code of a user(s) of the node, telephone area code for a telephone number assigned to the node, IP subnet address of the node, and the like, as well as various combinations thereof.

The network location of a node may specify information such as the Internet Service Provider (ISP) of the node, an access network by which the node obtains network access, and the like, as well as various combinations thereof. In one embodiment, the node can request (e.g., from its own ISP) information as to where other nodes are located with respect to the ISP network of the ISP, and the node may then provide this information to the conference management server for use in determining the network location of the node. The network location of the node may be determined in any other suitable manner.

The device capability information for a node includes information indicative of a number of media streams which the node is capable of duplicating and redistributing. The device capability information for a node may be specified directly (e.g., as a number of media streams which the node is capable of duplicating and redistributing) or indirectly (e.g., where the number of media streams which the node is capable of duplicating and redistributing is derived using information such as processing power of the node, memory available at the node, network access bandwidth available to the node, and like information associated with the conference participant node, as well as various combinations thereof). It is to be understood that each conference participant node is at least capable of receiving at least one media stream.

The media content communication information for a node may include any information which may be used for communication with the node, such as the IP address and port of the node on which the node would like to receive packets conveying media content.

The media distribution tree establishment information for a conference participant node may be determined locally (e.g., from local storage that is associated with the element(s) executing method 200). The media distribution tree establishment information for a conference participant node may be received at the element(s) executing method 200 (e.g., obtained by the element(s) from one or more other elements within the network, provided to the element(s) by, or on behalf of, the conference participant node in advance of and/or at the time of establishment of the media distribution tree, and the like, as well as various combinations thereof). It will be appreciated that the media distribution tree establishment information may be determined from any suitable source(s) of such information in any suitable manner for determining such information.

At step 206, a media distribution tree is determined using the media distribution tree establishment information. The media distribution tree specifies a topology of the media distribution network to be formed.

In one embodiment, the media distribution tree is determined by: (1) grouping conference participant nodes into regions based on locations of the conference participant nodes, (2) determining, for each region, a regional tree specifying a regional network to be formed by conference participants nodes grouped into that region, and (3) connecting the regional trees to form the media distribution tree.

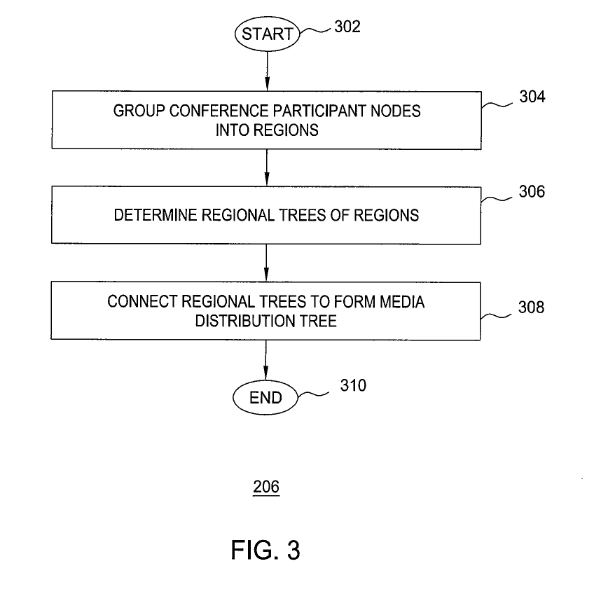

A method, according to one embodiment, for determining a media distribution tree, is depicted and described with respect to FIG. 3.

At step 208, media distribution tree connectivity information is determined.

The media distribution tree connectivity information is determined based on the media distribution tree (i.e., on the determined topology of the media distribution tree to be established in the network).

The media distribution tree connectivity information is determined for use by the conference participant nodes to establish the media distribution tree in the network.

In one embodiment, the media distribution tree connectivity information includes (1) information for use in communicating with an upstream node, and (2) where applicable, information for use in communicating with one or more downstream nodes. The information for use in communicating with a node, upstream or downstream, may include information such as the identity of the node, the IP address and port number of the node, and like information, as well as various combinations thereof. The media distribution tree connectivity information may include any other information for use in enabling conference participant nodes to exchange media content via the media distribution tree.

At step 210, the media distribution tree connectivity information is propagated to the conference participant nodes for use by the conference participant nodes in establishing the media distribution tree in the network.

The media distribution tree connectivity information may be propagated to the conference participant devices in any suitable manner (e.g., using any suitable signaling protocol(s)). For example, the media distribution tree connectivity information may be propagated to the conference participant devices using the Session Initiation Protocol (SIP), H.323, and like suitable signaling protocols, as well as various combinations thereof.

For example, where a conference participant node encodes a “join conference” message within a SIP INVITE message (e.g., where media distribution tree establishment information is encoded within the body of a SIP INVITE message), the media distribution tree connectivity information may be propagated to the conference participant node using a SIP 200-OK response message (e.g., by encoding media distribution tree connectivity information in the body of the SIP 200-OK response message).

At step 212, the media distribution tree is established in the network by the conference participant nodes using the media distribution tree connectivity information. For example, the conference participant nodes may reserve local resources for use in supporting the media distribution tree, set up sessions with peer conference participant nodes for use in propagating media content over the media distribution tree (e.g., setting up RTP sessions), and the like, as well as various combinations thereof.

At step 214, method 200 ends.

Although omitted from FIG. 2 for purposes of clarity, those skilled in the art will appreciate that information associated with the media distribution tree, as well as various portions thereof, may be stored, displayed, propagated to one or more network elements, and the like, as well as various combinations thereof. In one embodiment, for example, the media distribution tree may be stored as it is being determined (e.g., the groupings of nodes into respective regions may be stored, as each regional tree is determined it may be stored until the regions are later connected to form the media distribution tree, and the like, as well as various combinations thereof). In one embodiment, for example, the media distribution tree may be stored after the media distribution tree has been determined (e.g., to make the media distribution tree available for use in determining the media distribution tree connectivity information, where there may be some delay between the determination of the media distribution tree and the establishment of the media distribution tree within the network, and the like, as well as various combinations thereof). It will be appreciated that information associated with the various components of the media distribution tree, the media distribution tree, the media distribution tree connectivity information, and the like may be handled in any other suitable manner, which may involve performing one or more of storing, displaying, propagating, and/or other suitable functions.

Although omitted from FIG. 2 for purposes of clarity, those skilled in the art will appreciate that, prior to establishment of a media distribution tree for a conference, the conference itself may be established. The establishment of a conference may be performed in any suitable manner. For example, a host of the conference may schedule a conference in advance, or may request a conference on-the-fly. The conference host may provide a conference management server within a list of participants for the conference. The conference host may provide participants with authentication information by which the participants may join the conference (and, thus, be joined to the media distribution tree for the conference). It will be appreciated that the distributed multimedia conferencing capabilities depicted and described herein are not intended to be limited to any particular manner of scheduling, establishing, managing, or terminating a conference for which a media distribution tree is established.

Although omitted from FIG. 2 for purposes of clarity, those skilled in the art will appreciate that, in addition to determining the media distribution tree connectivity information and propagating the media distribution tree connectivity information to the conference participant nodes for use by the conference participant nodes in establishing the media distribution tree, one or more conference facilitating nodes (e.g., one or more media distribution servers) also may be configured to establish the media distribution tree in the network. For example,one or more ports may be allocated at the media distribution server(s) supporting the media distribution tree.

Although omitted from FIG. 2 for purposes of clarity, those skilled in the art will appreciate that additional actions may be performed after the media distribution tree is established (e.g., modifying media distribution tree topology as new nodes join the conference and existing nodes leave the conference, terminating the media distribution tree at the conclusion of the conference, and the like, as well as various combinations thereof).

A method, according to one embodiment, for determining a media distribution tree, is depicted and described with respect to FIG. 3.

FIG. 3 depicts an exemplary embodiment of a method for determining a media distribution tree.

Although primarily depicted and described herein as being performed serially, at least a portion of the steps of method 300 may be performed contemporaneously, or in a different order than depicted and described with respect to FIG. 3.

At step 302, method 300 begins.

At step 304, conference participant nodes are grouped into regions.

The conference participant nodes are grouped into regions based on location information associated with each of the conference participant nodes, which may include geographic and/or network location information.

In one embodiment, conference participant nodes are grouped into regions based on geographic locations of the conference participant nodes. In one such embodiment, network location information also may be taken into account when grouping conference participant nodes into regions. For example, where two conference participant nodes are located relatively close to each other geographically (based on the geographic area covered by the full set of conference participant nodes being considered), but at connected to two different ISPs, the two conference participant nodes may be placed in different regions (e.g., where the two ISPs are connected through a special gateway(s) that is located relatively far, geographically, from the conference participant nodes).

In one embodiment, the regions into which conference participant nodes are to be grouped may be determined prior to the grouping of the conference participant nodes into regions. The regions may be determined in any suitable manner.

In one embodiment, regions into which conference participant nodes are to be grouped may be determined by dividing a geographic coverage area into regions. The geographic coverage area may be associated with the customer, a particular conference to be provided for the customer (e.g., based on geographic locations of the participants of the conference, and the like.

For example, where a conference is for a global company with participants around the world, each continent may be classified as a region.

For example, where a conference is for a U.S.-based company with offices around the country, each state may be classified as a region. If the U.S. based company has a lot of activity in one particular state, that state may be subdivided into multiple regions. Similarly, if the U.S. based company has locations in less active states, multiple states may be consolidated into a single region.

From these examples, it will be appreciated that the locations/sizes of regions are relative, and any granularity may be supported.

In one embodiment, a geographic information database is maintained, for storing such geographic location information.

The geographic location information may be independent of a user (e.g., where coverage areas are defined using templates, which may be shared by multiple users). For example, all global users may utilize one or more generic “global” templates, in which each continent or country may be classified as a region. For example, all users having operations in the U.S. may utilize one or more generic “US” templates, in which regions of the country are classified as regions, individual states are classified as regions, and the like.

The geographic location information may be specific to a user (e.g., where the regions are tailored to the specifics of that user). The geographical location information stored in the geographic information database for a user may specify regions pre-computed for the user and/or may specify information adapted for use in determining regions for the user on-the-fly (e.g., on a conference-by-conference basis based on the geographic coverage area of the participants scheduled to participate in the conference). For example, the geographic location information adapted for use in determining regions for a customer on-the-fly may include information such as addresses of offices of the customer, the numbers of people located at each office of the customer, and like information which may be used to divide a coverage area for the customer into appropriate regions.

In one embodiment, geographic location information maintained in the geographic information database may include information indicative of the “distance” between regions, which may be a geographic distance, a network distance (e.g., in terms of delay), a measure of the desirability of connecting two regions, or any other suitable measure.

In one embodiment, the number of regions into which conference participant nodes are to be grouped may be pre-determined.

In one embodiment, the number of regions into which conference participant nodes are to be grouped may be estimated. The number of regions into which conference participant nodes are to be grouped may be estimated in a number of ways.

In one embodiment, the number of regions into which conference participant nodes are to be grouped may be estimated by determining (1) the total number of conference participant nodes that are expected to participate in the conference and (2) the average number of conference participant nodes expected to be part of each region. From this information, the number of regions into which conference participant nodes are to be grouped may be estimated by dividing the total number of conference participant nodes that are expected to participate in the conference by the average number of conference participant nodes expected to be part of each region.

In one embodiment, the average number of conference participant nodes expected to be part of each region may be estimated based on (1) the average capability of the conference participant nodes (e.g., average for all conference participant nodes in a company, average for the conference participant nodes expected to participate in the conference, and the like, as well as various combinations thereof) and (2) the policy of the company regarding the depths of the regional trees to be formed for the respective regions.

As an example, if the average capability of nodes in a company is order=2 (not counting inter-regional connections) and the policy of the company is to keep the depth of the regional trees at a maximum of two levels (depth=2), then the maximum size of any regional network is 7 nodes. From this, the average number of conference participant nodes expected to be part of each region may be estimated to be approximately 4 to 5 nodes.

As another example, if the average capability of nodes in a company is order=3 (not counting inter-regional connections) and the policy of the company is to keep the depth of the regional trees at a maximum of two levels (depth=2), then the maximum size of any regional network is 13 nodes. From this, the average number of conference participant nodes expected to be part of each region may be estimated to be approximately 7 to 8 nodes.

In one embodiment, the number of ports to be allocated at the media distribution server(s) may be estimated based on the determined or estimated number of regions for the conference. The number of ports to be allocated at the media distribution server(s) may be estimated based on a maximum depth threshold of the backbone tree, the number of ports available within each regional tree to support inter-region connections, and the like, as well as various combinations thereof.

As an example, assume that a conference will have or is estimated to have 12 regions. Depending on the above-described factors, the number of ports to be allocated at the media distribution server(s) may vary, resulting in different configurations of the backbone tree for the media distribution tree.

In one configuration, 12 ports will be allocated at the media distribution server, one for each region. In this configuration, each region is connected directly to the media distribution server such that none of the regions needs to allocate ports for inter-region connectivity. This configuration will have the best transit delay, at the expense of consuming a large number of ports at the media distribution server.

In another configuration, if each of the regions can support at least one port for inter-region connectivity, then 6 ports can be allocated at the media distribution server. In this configuration, 6 regions are connected directly to the media distribution server, and the remaining 6 regions are connected to the first 6 regions using 1:1 pairings. In this case, the backbone tree has a depth of 2 hops, which increases transit delay, but with the advantage that less of the ports of the media distribution server (i.e., 6, instead of 12) will be consumed for the conference.

In another configuration, if each of the regions can support at least two ports for inter-region connectivity, then 4 ports can be allocated at the media distribution server. In this configuration, 4 regions are connected directly to the media distribution server, and the remaining 8 regions are connected to the first 4 regions (e.g., two of the remaining regions connected to each of the 4 regions connected directly to the media distribution server). In this case, the backbone tree has a depth of 2 hops, which increases transit delay, but with the advantage that less of the ports of the media distribution server (i.e., 4, instead of 6 or 12) will be consumed for the conference.

It will be appreciated that determination of a backbone tree for a media distribution tree may be implemented in various other ways (e.g., using other types of information in a different manner, and resulting in other types of configurations). The exemplary configurations described above are merely provided for illustrative purposes.

In one embodiment, the number of ports to be allocated at the media distribution server(s) may be estimated as ½ to ¾ of the number of regions determined or estimated for the conference.

In one embodiment, the initial estimate of the number of ports to be allocated at the media distribution server(s) may be further refined as more information becomes available.

In one embodiment, the number of ports actually allocated at the media distribution server(s) may be modified as needed (e.g., de-allocating ports if the ports are no longer required, allocating additional ports if additional ports are required, and the like, as well as various combinations thereof).

It will be appreciated that the actual number of regions for a conference may be different than the estimated number of regions for the conference. The difference between the actual and estimated number of regions may be due to one or more factors, such as where device capability information for conference participant nodes is not known a priori (e.g., where capability depends on access bandwidth), where not all regions have the same inter-regional connectivity, where not all regions will be constrained to have the same regional tree depth restrictions, and like factors, as well as various combinations thereof.

At step 306, regional trees for the respective regions are determined. A regional tree for a region specifies organization of the conference participant nodes of the region to form a regional network (i.e., the topology of the regional network to be formed for the region).

A regional tree for a region includes a regional root node, which is the conference participant node (or, optionally, media distribution server) which will be interconnected to other regions (directly and/or indirectly via a backbone root node, such as a media distribution server) to form the media distribution tree.

In one embodiment, the regional root node of a region is capable of supporting media distribution within the region. In this embodiment, the regional root node will have at least one port available for intra-region communications.

In one embodiment, the regional root node of a region is capable of supporting media distribution with other regions. In this embodiment, the regional root node will have at least one port available for inter-region communications.

In one embodiment, the regional root node of a region may be the only node in the region. In one such embodiment, the regional root node will not have any ports available for intra-region or inter-region communications and, thus, the region will be a leaf in the backbone tree without any corresponding children in the backbone tree. An example is where the user device is a handheld PDA, which typically can receive content but does not include the processing power or the bandwidth to operate as a relay point within the media distribution tree. It will be appreciated that other types of user devices also may have limited processing power and/or bandwidth, such that the user device cannot operate as a relay point.

In one embodiment, the regional root node may include a combination of such capabilities.

In one embodiment, the regional root is the most capable node in the region as (a) this would reduce the depth the regional tree and, thus, provide better delay characteristics, and (b) the resulting regional tree would be capable of supporting more nodes. It will be appreciated, however, that this is not always required.

In one embodiment, a regional tree for a region is determined in a manner for increasing the width of the regional tree and decreasing the depth of the regional tree.

In one embodiment, a regional tree for a region is determined using order information associated with the conference participant nodes (e.g., where each conference participant node has a respective order associated therewith). The order of a conference participant node indicates a number of media streams that the conference participant node is capable of replicating and distributing. As described herein, the order of a conference participant node may be specified directly, or may be derived from device capability information associated with the respective conference participant node (e.g., such as processing power, memory available, access bandwidth, and the like). In one embodiment, a regional tree for a region is determined in a manner for placing higher order nodes (i.e., nodes more capable of supporting media streams) toward the top of the regional tree (i.e., toward the root of the regional tree) and placing lower order nodes (i.e., nodes less capable of supporting media streams) toward the bottom of the regional tree.

In one embodiment, geographic location information and/or network location information associated with at least a portion of the conference participant nodes of a region may be utilized in determining the regional tree for the region. In one such embodiment, node order information of the nodes may be considered first, with geographic and/or network location information being given less weight in determining the regional tree of the region (e.g., for use for tiebreaking purposes during use of the node order information as the primary basis for determining the regional tree of the region.

The use of node order information, instead of (or at least with more weight than) node location information, may be performed since all of the nodes within a region are expected to be relatively close to each other, such that the focus of the design of the regional tree should be to provide good delay performance (e.g., by positioning the most capable conference participant nodes near the top of the regional tree and positioning the least capable conference participant nodes near the bottom of the tree).

A regional tree for a regional tree may be determined using any suitable algorithm for determining a tree topology. In one embodiment, the same algorithm may be used for determining the regional trees for each of the regions of the media distribution tree. In one embodiment, multiple algorithms may be used for determining the regional trees for the regions, such that different algorithms may be used for different regions of the media distribution tree.

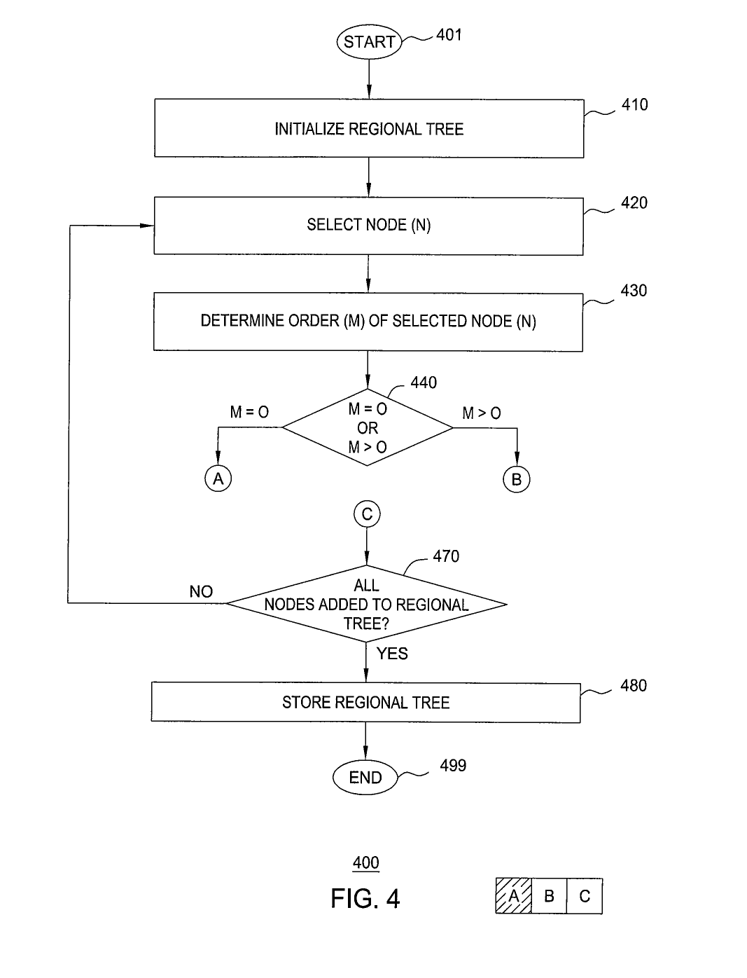

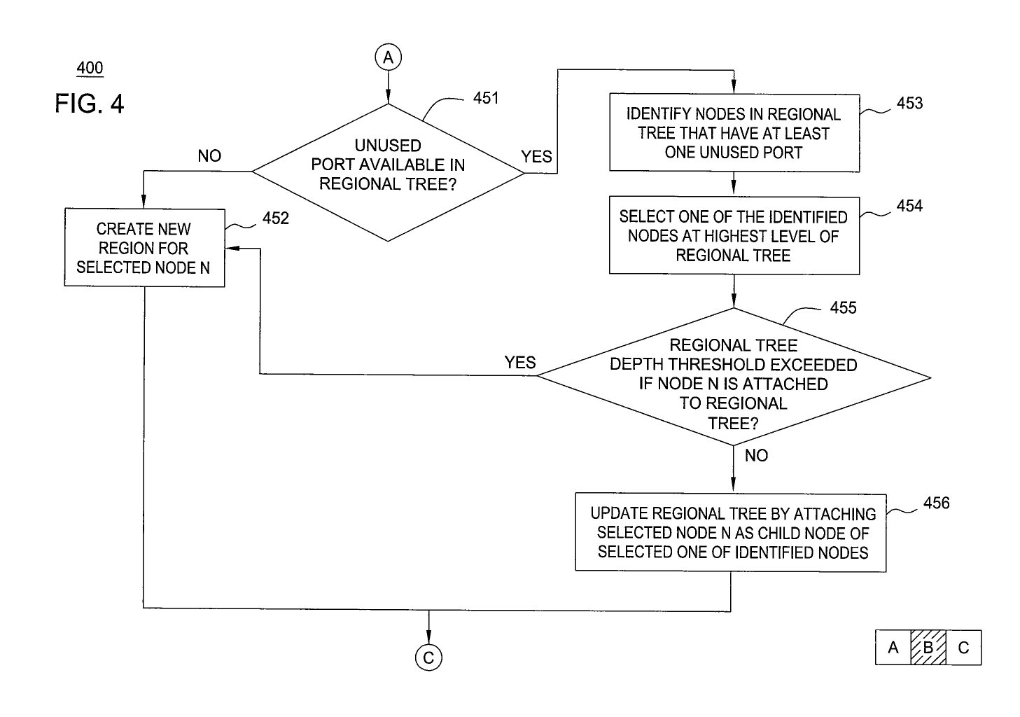

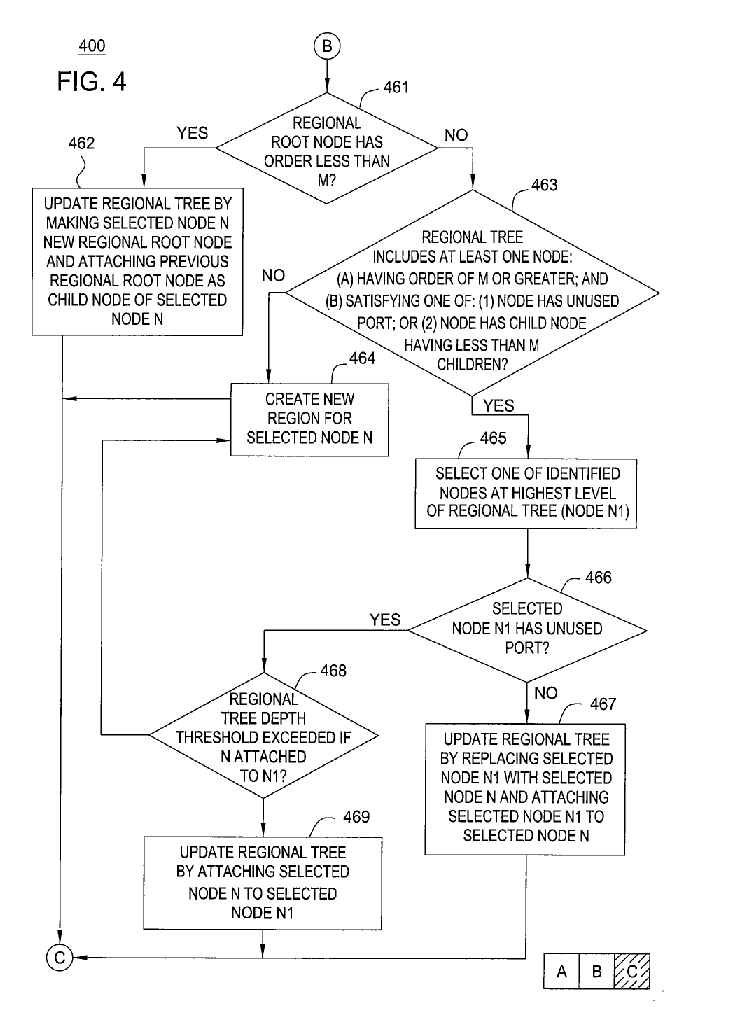

A method according to one exemplary embodiment for determining a regional tree for a region is depicted and described with respect to FIG. 4

At step 308, the regional trees are connected to form the media distribution tree. The connection of the regional trees (regions) specifies a backbone tree for the media distribution tree, such that the backbone tree and the regional trees, together, specify the topology of the media distribution tree.

In one embodiment, the regional trees are connected by interconnecting the regional root nodes of the respective regions.

In one embodiment, regional root nodes of the respective regions may be interconnected via a media distribution server (or servers), which forms the root of the media distribution tree. In this embodiment, all of the regions may be directly connected to the media distribution server, or only a subset of the regions may be directly connected to the media distribution server. The number of regions connected to the media distribution server may depend on the number of ports available at the media distribution server. For example, where the conference participant nodes are divided into ten regions, but only six ports can be made available at the media distribution server, six of the regions may be directly connected to the media distribution server and the remaining four regions may be connected to other ones of the regions.

The number of ports available at a media distribution server may be predetermined, or may be determined on-the-fly. The number of ports available at a media distribution server may be fixed, or may be modified dynamically as needed or desired (e.g., based on one or more factors or constraints).

In one embodiment, regional root nodes of the respective regions may be interconnected without use of any media distribution server. In one such embodiment, one of the regional root nodes may be selected as the root of the media distribution tree. In another such embodiment, the multiple regional root nodes may cooperate to operate as the root of the media distribution tree.

In one embodiment, the regions are interconnected in a manner for satisfying one or more constraints, such as minimizing or reducing network distance, satisfying a hop count threshold (e.g., no region can be more than a certain number of hops from the root of the media distribution tree, no region can be more than a certain number of hops from any other region of the media distribution tree, and the like), and/or any other suitable constraint, as well as various combinations thereof.

At step 310, method 300 ends.

FIG. 4 depicts an exemplary embodiment of a method for determining a regional tree for conference participant nodes grouped into a region.

Although primarily depicted and described herein as being performed serially, at least a portion of the steps of method 400 may be performed contemporaneously, or in a different order than depicted and described with respect to FIG. 4.

At step 401, method 400 begins.

At step 410, a regional tree is initialized. If the regional tree is being determined for the first time, the regional tree is initialized to be empty. If the regional tree is being updated, the regional tree is initialized to have its current topology (e.g., where the method 400 is utilized when a conference participant node(s) joins an existing media distribution tree). The regional tree is then determined/updated by considering each of the conference participant nodes, in turn, to determine the positions of the nodes within the regional tree.

At step 420, a node (N) is selected. The selected node N is a node that has not yet been added to the regional tree.

At step 430, the order (m) of the selected node N is determined. The order m of a node is representative of the number of media streams that the node is capable of replicating and distributing.

At step 440, a determination is made as to whether the order m of selected node N is zero or greater than zero. The order m of selected node N determines the manner in which the selected node N is added to the regional tree. If the order m of selected node N is zero, method 400 proceeds to step 451. If the order m of selected node N is greater than zero, method 400 proceeds to step 461.

At step 451, a determination is made as to whether there is an unused port available in the regional tree. If there is not an unused port available in the regional tree, method 400 proceeds to step 452. If there is an unused port available in the regional tree, method 400 proceeds to step 453.

At step 452, a new region is created for selected node N.

At step 453, all nodes in the regional tree that have at least one unused port are identified.

At step 454, one of the identified nodes is selected.

In one embodiment, the selected one of the identified nodes is one of the identified nodes that is at the highest level of the regional tree (i.e., closest to the root of the regional tree). If multiple identified nodes are at the same level of the regional tree, one of the multiple nodes is selected. The one of the multiple nodes may be selected using one or more factors (serially and/or in combination) as a tie-breaker. In one embodiment, for example, the node with the most unused ports is selected. In one embodiment, for example, the node having a sub-tree with the smallest associated depth is selected. In one embodiment, for example, the node having a sub-tree with the least number of nodes is selected. In one embodiment, for example, the node with the most unused ports will be selected first, then the node having a sub-tree with the smallest associated depth will be selected, then the node having a sub-tree with the least number of nodes will be selected. If there is still a tie between multiple identified nodes after considering such factors, one of the nodes (e.g., one of the multiple identified nodes or one of a subset of the multiple identified nodes narrowed based on such factors) may be selected randomly.

At step 455, a determination is made as to whether a regional tree depth threshold of the regional tree will be exceeded if selected node N is attached to the selected one of the identified nodes. If the regional tree depth threshold of the regional tree will be exceeded if selected node N is attached to the selected one of the identified nodes, method 400 proceeds to step 452, at which point a new region is created for selected node N. If the regional tree depth threshold of the regional tree will not be exceeded if selected node N is attached to the selected one of the identified nodes, method 400 proceeds to step 456.

At step 456, the regional tree is updated by attaching selected node N to the selected one of the identified nodes as a child of the selected one of the identified nodes. The selected node N is attached to an unused port of the selected one of the identified nodes.

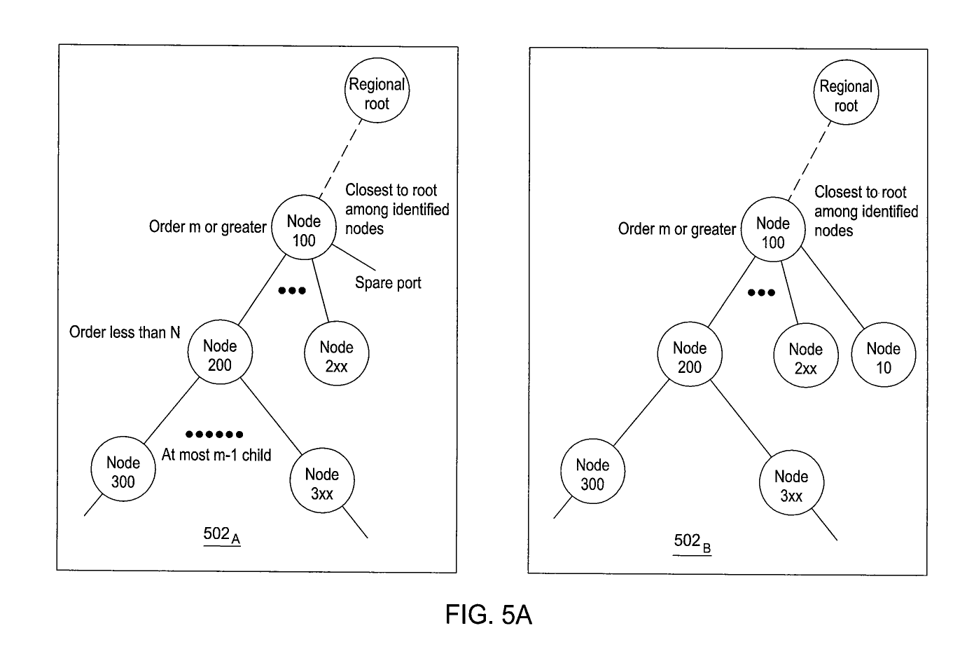

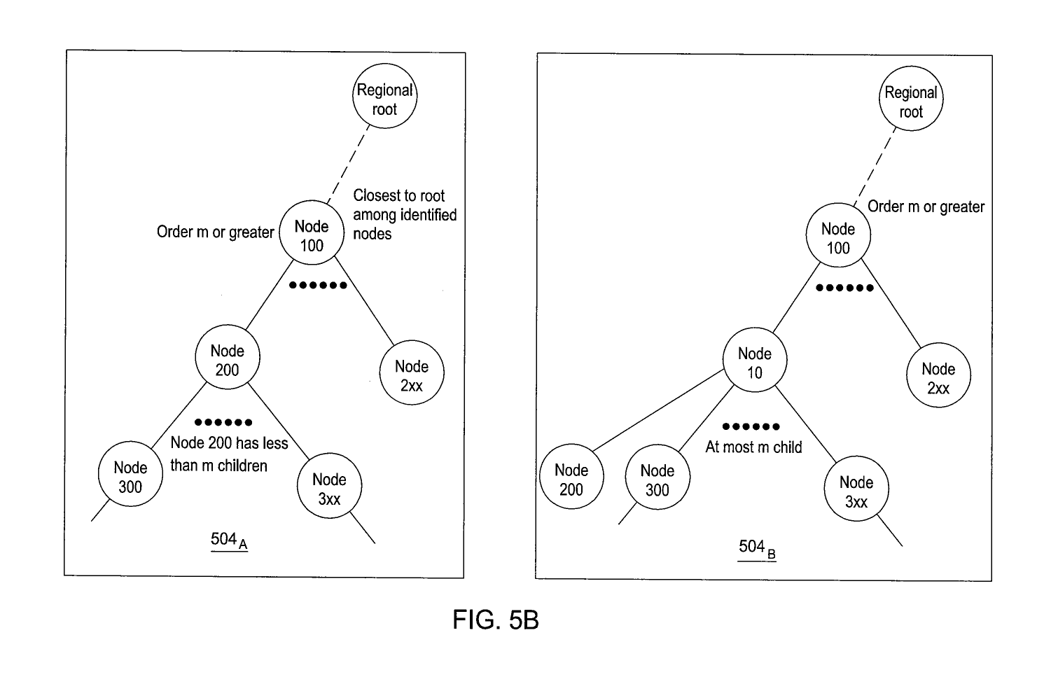

The steps 451-456 provide a process for determining the position of the selected node N within a regional tree where the selected node N is not capable of replicating and distributing any media streams. An example of this process is depicted and described with respect to FIG. 5A. From steps 452 and 456, method 400 proceeds to step 470.

At step 461, a determination is made as to whether the regional root node of the regional tree has an order of less than m. If the regional root node of the regional tree has an order of less than m, method 400 proceeds to step 462. If the regional root node of the regional tree does not have an order of less than m (i.e., it has an order of m or greater), method 400 proceeds to step 463.

At step 462, the regional tree is updated by making selected node N the new regional root node, and attaching the previous regional root node and all of the children of the previous regional root node to selected node N as children of selected node N.

At step 463, a determination is made as to whether the regional tree includes at least one node having an associated order of m or greater and satisfying at least one of (1) have at least one unused port, or (2) have a child node that has less than m children. The determination as to whether at least one node satisfying such conditions is included in the regional tree may be made by identifying each node of the regional tree satisfying such conditions. If the regional tree does not include any nodes satisfying these conditions, method 400 proceeds to step 464. If the regional tree does include at least one node satisfying these conditions, method 400 proceeds to step 465.

At step 464, a new region is created for selected node N.

At step 465, one of the identified nodes (i.e., one of the identified nodes satisfying the conditions of step 462) is selected. The selected one of the identified nodes is one of the identified nodes that is at the highest level of the regional tree (i.e., closest to the root of the regional tree). If multiple identified nodes are at the same level of the regional tree, one of the multiple nodes is selected. The one of the multiple nodes may be selected using one or more factors (serially and/or in combination) as a tie-breaker. In one embodiment, for example, the node with the most unused ports is selected. In one embodiment, for example, the node having a sub-tree with the least number of nodes is selected. In one embodiment, for example, the node with the most unused ports will be selected first, and then the node having a sub-tree with the least number of nodes will be selected. If there is still a tie between multiple identified nodes after considering such factors, one of the nodes (e.g., one of the multiple identified nodes or one of a subset of the multiple identified nodes narrowed based on such factors) may be selected randomly. The selected one of the identified nodes is denoted as selected node N1.

At step 466, a determination is made as to whether selected node N1 has an unused port available. If an unused port is not available at selected node N1, method 400 proceeds to step 467. If an unused port is available at selected node N1, method 400 proceeds to step 468.

At step 467, the regional tree is updated by replacing selected node N1 with selected node N and attaching selected node N1 to selected node N as a child node of selected node N.

At step 468, a determination is made as to whether a regional tree depth threshold of the regional tree will be exceeded if selected node N is attached to selected node N1. If the regional tree depth threshold of the regional tree will be exceeded if selected node N is attached to selected node N1, method 400 returns to step 464, at which point a new region is created for selected node N. If the regional tree depth threshold of the regional tree will not be exceeded if selected node N is attached to selected node N1, method 400 proceeds to step 469.

At step 469, the regional tree is updated by attaching selected node N to selected node N1. The selected node N is attached to an unused port of selected node N1.

The steps 461-469 provide a process for determining the position of the selected node N within a regional tree where the selected node N is capable of replicating and distributing any media streams. An example of this process (where one of the nodes of the regional tree has an associated order of m or greater) is depicted and described with respect to FIG. 5B. From steps 462, 464, 467, and 469, method 400 proceeds to step 470.

At step 470, a determination is made as to whether all nodes of the region have been added to the regional tree. If all of the nodes of the region have not been added to the regional tree, method 400 returns to step 410. If all of the nodes of the region have been added to the regional tree, method 400 proceeds to step 480.

At step 480, the regional tree is stored. The regional tree is stored for later use in updating the regional tree when nodes join and leave the region, for determining the media distribution tree, and the like, as well as various combinations thereof. It will be appreciated that the regional tree also may be displayed, propagated to one or more other nodes, and the like, as well as various combinations thereof.

At step 499, method 400 ends.

As described herein, using exemplary method 400 of FIG. 4 enables the regional tree to be arranged such that nodes with the highest order (i.e., the most capable nodes) are closest to the regional root node, such that the width of the tree is maximized while the depth of the tree is minimized, and such that the regional tree is more balanced, thereby enabling the regional network that is established according to the regional tree to provide improved performance (e.g., in terms of response time and/or other quality-of-service measures).

As described hereinabove, it will be appreciated that other methods of determining a regional tree for a region may be used to provide similar benefits.

In one embodiment, for example, for at least one of the regions, the associated regional tree is determined in a manner for increasing a width of the regional tree and decreasing a depth of the regional tree.

In one embodiment, for example, for at least one of the regions, the associated regional tree is determined by selecting one of the nodes grouped into the region, and determining the position of the selected node within the regional tree by placing the node into the regional tree such that the following conditions are satisfied: (a) all of the nodes of the regional tree between the selected node and a regional root node of the regional tree have an associated order equal to or greater than an order of the selected node, wherein the order of a node is indicative of a number of intra-region media streams that the selected node is capable of replicating and distributing; (b) the selected node is closest to the regional root node while satisfying (a); (c) a maximum allowable depth of the regional tree is not exceeded; and, wherein, if any of conditions (a), (b), or (c) cannot be satisfied, a new region is created for the selected node. In one such embodiment, this process may be repeated for each of the nodes grouped in the region until all of the nodes grouped into the region have been positioned within the regional tree.

In one embodiment, for example, for at least one of the regions, the associated regional tree is determined by selecting one of the nodes grouped into the region, and determining a position of the selected node within the regional tree based on an order of the selected node, wherein the order of the selected node is indicative of a number of intra-region media streams that the selected node is capable of replicating and distributing. In one such embodiment, this process may be repeated for each of the nodes grouped in the region until all of the nodes grouped into the region have been positioned within the regional tree.

It will be appreciated that such conditions and constraints may be satisfied using various different methods, such as method 400 depicted and described herein with respect to FIG. 4, as well as any other suitable methods for satisfying such conditions and constraints.

Although primarily depicted and described herein with respect to use of the method 400 of FIG. 4 during initial establishment of a media distribution tree, it will be appreciated that at least a portion of the logic of method 400 also may be executed when individual conference participant nodes join an existing media distribution tree.

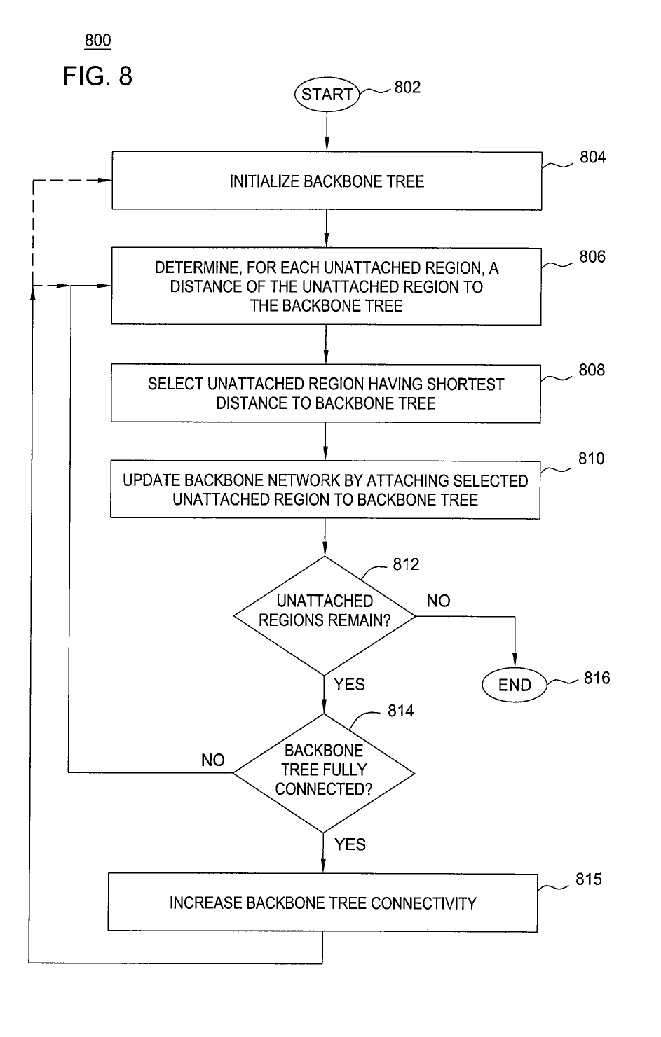

In one embodiment, for example, when a conference participant node (N) first joins a conference (and, thus, will be added to the media distribution tree of the conference), if no node from the same region as the joining node is part of the media distribution tree then a new region will be formed with node N being the only member of the new region. In this embodiment, the node N may be attached directly to the backbone tree of the media distribution tree (i.e., to the root of the media distribution tree, or to one of the regional root nodes of the media distribution tree). The joining of the node N to the backbone tree may be performed as depicted and described herein with respect to FIG. 8.

In one embodiment, for example, when a conference participant node (N) first joins a conference (and, thus, will be added to the media distribution tree of the conference), if processing of the new node N for determining its position within the regional tree indicates that a new region should be formed for node N (e.g., such as at steps 452 or 464), a new region will be formed with node N being the only member of the new region. In this embodiment, the node N may be attached directly to the backbone tree of the media distribution tree (i.e., to the root of the media distribution tree, or to one of the regional root nodes of the media distribution tree). The joining of the node N to the backbone tree may be performed as depicted and described herein with respect to FIG. 8.

FIG. 5A depicts an example illustrating the manner in which a regional tree is updated to include a conference participant node that is not capable of replicating and distributing any media streams. This example is associated with steps 451-456 of method 400 of FIG. 4. As depicted in FIG. 5A, two states of an exemplary regional tree are shown. A first state of the exemplary regional tree, denoted as 502_{A}, depicts the exemplary regional tree before a new node (node 10) is added. A second state of the exemplary regional tree, denoted as 502_{B}, depicts the exemplary regional tree after a new node (node 10) has been added.

In the first state, the exemplary regional tree includes a regional root node, a node 100 (of order m or greater) that is a child of the regional root node, a plurality of nodes 200-2xx that are each children of node 100, and a plurality of nodes 300-3xx that are each children of the node 200. The exemplary regional tree may include other nodes which are not depicted. The node 100 is the closest node to regional root node among identified nodes. The node 100 has an unused port. The new node 10, which is being added to the regional tree, has an order of m=0.

In the second state, the exemplary regional tree is identical to the first state of the exemplary regional tree, except that new node 10 has been added to the regional tree as a child of node 100. The new node 10 is attached to the previously unused port of the node 100. As described hereinabove with respect to steps 451-456 of FIG. 4, since the order of new node 10 is zero, and there is an unused port available in the regional tree, one of the nodes in the regional tree that has an unused port is selected. In one embodiment, the one of the nodes that is selected is the one at the highest level of the tree (illustratively, node 100). The new node 10 is added to an unused port of the selected node (i.e., to the unused port of node 100, which is a child node of the regional root node).

FIG. 5B depicts an example illustrating the manner in which a regional tree is updated to include a conference participant node that is capable of replicating and distributing one or more media streams. This example is associated with steps 461-469 of method 400 of FIG. 4. As depicted in FIG. 5B, two states of an exemplary regional tree are shown. A first state of the exemplary regional tree, denoted as 504_{A}, depicts the exemplary regional tree before a new node (node 10) is added. A second state of the exemplary regional tree, denoted as 504_{B}, depicts the exemplary regional tree after a new node (node 10) has been added.

In the first state, the exemplary regional tree includes a regional root node, a node 100 (of order m or greater) that is a child of the regional root node, a plurality of nodes 200-2xx that are each children of node 100, and a plurality of nodes 300-3xx that are each children of the node 200. The exemplary regional tree may include other nodes which are not depicted. The node 100 is the closest node to the regional root node among identified nodes. The node 100 does not have any unused ports. The node 200 has less than m children. The new node 10, which is being added to the regional tree, has an order of m>0.

In the second state, the exemplary regional tree is identical to the first state of the exemplary regional tree, except that new node 10 has been added to the regional tree as a child of node 100 and as a parent of node 200 and nodes 300-3xx. As described hereinabove with respect to steps 461-469 of FIG. 4, since the order of new node 10 is greater than zero, all nodes of the regional tree having an associated order of m or greater (and that (1) have at least one unused port, or (2) have a child node that has less than m children) are identified, and one of the identified nodes is selected (illustratively, node 100). As further described hereinabove with respect to steps 461-469 of FIG. 4, since node 100 does not have any ports available, the child node of the selected node 100 having an associated sub-tree with the least number of nodes is selected (illustratively, node 200). The new node 10 is attached between node 100 and node 200, and node 200 and the children of node 200 (nodes 300-3xx) are re-homed to be children of new node 10.

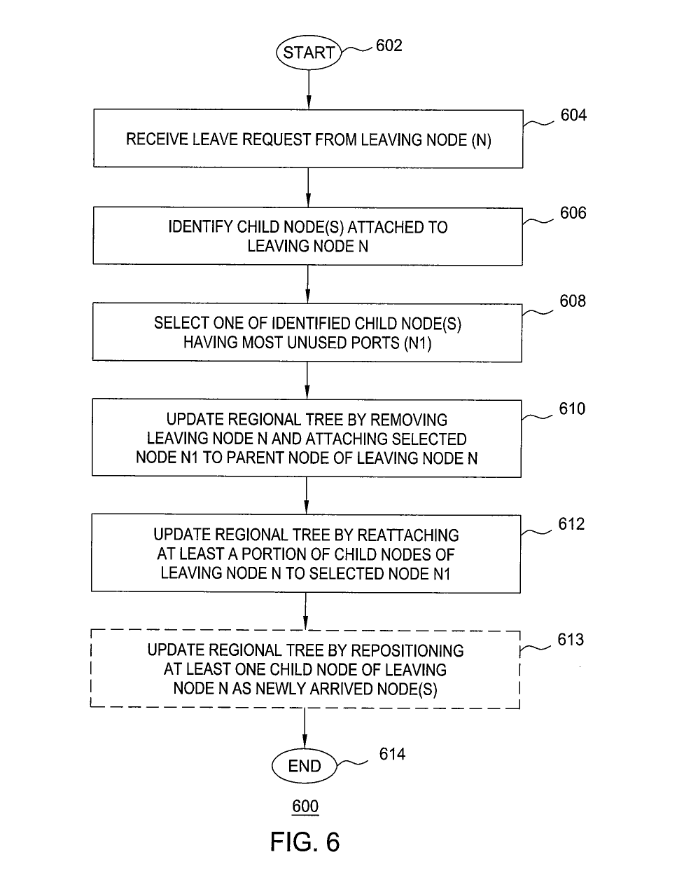

FIG. 6 depicts an exemplary embodiment of a method for updating a regional tree when a conference participant node leaves an existing media distribution tree.

Although primarily depicted and described herein as being performed serially, at least a portion of the steps of method 600 may be performed contemporaneously, or in a different order than depicted and described with respect to FIG. 6.

At step 602, method 600 begins.

At step 604, a leave request is received from a conference participant node (denoted as departing node N).

At step 606, the child nodes attached to departing node N are identified.

At step 608, one of the identified child nodes is selected (denoted as selected node N1). In one embodiment, the selected one of the child nodes is the child node having the most unused ports. It will be appreciated that, where departing node N only has one child node attached thereto, the one child node is selected automatically.

At step 610, the regional tree is updated by removing departing node N and attaching selected node N1 to the parent node of departing node N.

At step 612, the regional tree is updated by reattaching at least a portion of the child nodes of departing node N to selected node N1.

At step 613, an optional step, the regional tree is updated by repositioning at least one child node of departing node N as a newly arrived node(s).

At step 614, method 600 ends.

Although depicted and described with respect to an exemplary embodiment of a method for updating a regional tree when a conference participant node leaves an existing media distribution tree, it will be appreciated that updating of a regional tree when a conference participant node leaves an existing media distribution tree may be performed in any other suitable manner (e.g., in any other manner for satisfying constraints which may be accounted for in determining and updating regional trees, as depicted and described herein).

In one embodiment, when a user leaves a conference, the user device of the user may still operate as a relay point for the conference as long as the user gives permission. This will cause little or no disruption to the media distribution tree being used for the conference.

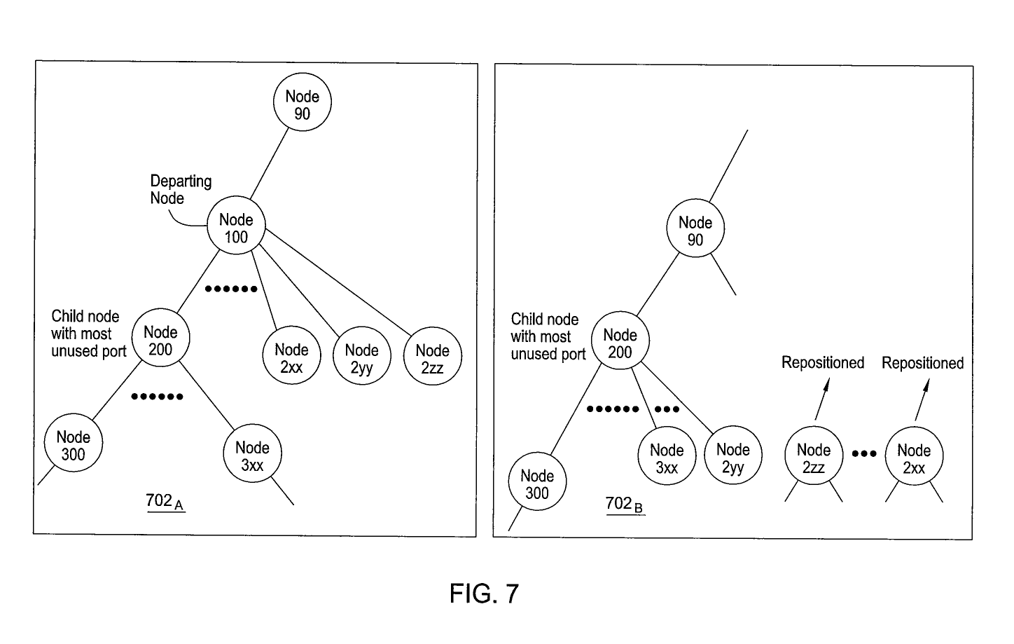

FIG. 7 depicts an example illustrating the manner in which a regional tree is updated in response to a conference participant node leaving the media distribution tree. This example is associated with method 600 of FIG. 6. As depicted in FIG. 7, two states of an exemplary regional tree are shown. A first state of the exemplary regional tree, denoted as 702_{A}, depicts the exemplary regional tree before an existing node (node 100) leaves the regional tree. A second state of the exemplary regional tree, denoted as 702_{B}, depicts the exemplary regional tree after the existing node (node 100) leaves the regional tree.

In the first state, the exemplary regional tree includes a regional root node, a node 100 that is a child of the regional root node, a plurality of nodes 200-2xx, 2yy, and 2zz that are each children of node 100, and a plurality of nodes 300-3xx that are each children of the node 200. The exemplary regional tree may include other nodes which are not depicted. The node 100 is the node that is leaving the regional tree. The node 200 is the child node of departing node 100 having the most unused ports available.

In the second state, the node 100 has been removed from the regional tree. The node 200 has been selected to move up a level in the regional tree, such that node 200 becomes a child of node 90. The node 200 is selected to replace node 100 because node 200 is the child of node 100 having the most unused ports available. The nodes 300-3xx that were children of node 200 remain children of node 200. The node 2yy that was a child of node 100 is attached as a child of node 200. The nodes 2xx and 2zz there were children of node 100 are repositioned within the regional tree (e.g., by executing method 400 of FIG. 4 using nodes 2xx and 2zz as input nodes).

FIG. 8 depicts an exemplary embodiment of a method for forming a media distribution tree by interconnecting regional trees.

Although primarily depicted and described herein as being performed serially, at least a portion of the steps of method 800 may be performed contemporaneously, or in a different order than depicted and described with respect to FIG. 8.

At step 802, method 800 begins.

At step 804, a backbone tree is initialized. In one embodiment, the backbone tree is initialized without a root node. In one embodiment, the backbone tree is initialized to have a backbone root (e.g., such as a media distribution server which will operate as a root of the media distribution network, a region pre-selected as the root region, and the like, as well as various combinations thereof).

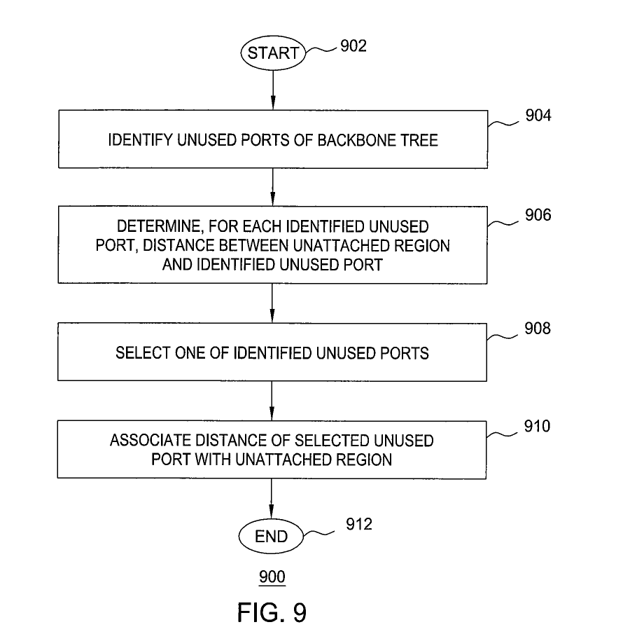

At step 806, for each unattached region, a distance of the unattached region to the backbone tree is determined. The distance of an unattached region to the backbone tree may be measured in a number of ways and, thus, may be determined in a number of ways. In one embodiment, distance of an unattached region to the backbone tree may be determined as depicted and described herein with respect to FIG. 9.

At step 808, the unattached region having the shortest distance to the backbone tree is selected. The selected unattached region is denoted as region M.

In one embodiment, if multiple unattached regions have the same shortest distance to the backbone tree, one of the multiple unattached regions having the same shortest distance to the backbone tree is selected randomly or using some other selection criteria.

In one embodiment, if multiple unattached regions have the same shortest distance to the backbone tree, the unattached region that will be closest to the backbone root if that unattached region is attached to the backbone tree is selected. In one further embodiment, if multiple unattached regions will have the same distance to the backbone root if those unattached regions are attached to the backbone tree, one of those multiple unattached region is selected randomly or using some other selection criteria.

At step 810, the backbone tree is updated by attaching the selected unattached region M to the backbone tree. In one embodiment, the selected unattached region M is attached to the backbone tree using a connection associated with the shortest distance.

At step 812, a determination is made as to whether any unattached regions remain. If at least one unattached regions remains, method 800 proceeds to step 814. If no unattached regions remain, method 800 proceeds to step 816.

At step 814, a determination is made as to whether the backbone tree is fully connected (i.e., whether or not any additional regions may be attached to the backbone tree). If the backbone tree is not fully connected, method 800 returns to step 806. If the backbone tree is fully connected, method 800 proceeds to step 815.

At step 815, backbone tree connectivity is increased. The backbone tree connectivity may be increased in any suitable manner, such as making one or more additional ports available at the backbone root, relaxing the maximum depth constraint of the regions, assigning an additional backbone root (e.g., an additional media distribution server), and the like, as well as various combinations thereof. From step 815, method 800 may return to step 806 (to continue processing unattached regions for inclusion within the backbone tree) or to step 804 (for reinitializing the backbone tree to only include the backbone root(s), in which case each previously attached region is reprocessed for inclusion in the backbone tree).

At step 816, method 800 ends.

FIG. 9 depicts an exemplary embodiment of a method for determining a distance of an unattached region to a backbone tree.

Although primarily depicted and described herein as being performed serially, at least a portion of the steps of method 900 may be performed contemporaneously, or in a different order than depicted and described with respect to FIG. 9.

At step 902, method 900 begins.

At step 904, unused ports of the backbone tree are identified. In one embodiment, the unused ports of the backbone tree that are identified include all unused ports of the backbone tree that are (a) allocated to support inter-region connectivity and (b) associated with regions that are not at full depth (i.e., for which a maximum depth constraint of the region has not yet been reached).

At step 906, for each of the identified unused ports, a distance between the unattached region and the unused port is determined. The distance between an unattached region and the unused port may be measured in any suitable manner (e.g., as a number of hops from the regional root node of the unattached region to the unused port, based on a measure indicative of delay between the unattached region and the unused port, and the like, as well as various combinations thereof).

At step 908, one of the identified unused ports is selected. In one embodiment, the selected one the identified unused ports is the identified unused port having a shortest distance to the unattached region.

At step 910, the distance of the selected one of the identified unused ports is associated with the unattached region (i.e., set as the distance of the unattached region to the backbone tree).

At step 912, method 900 ends.

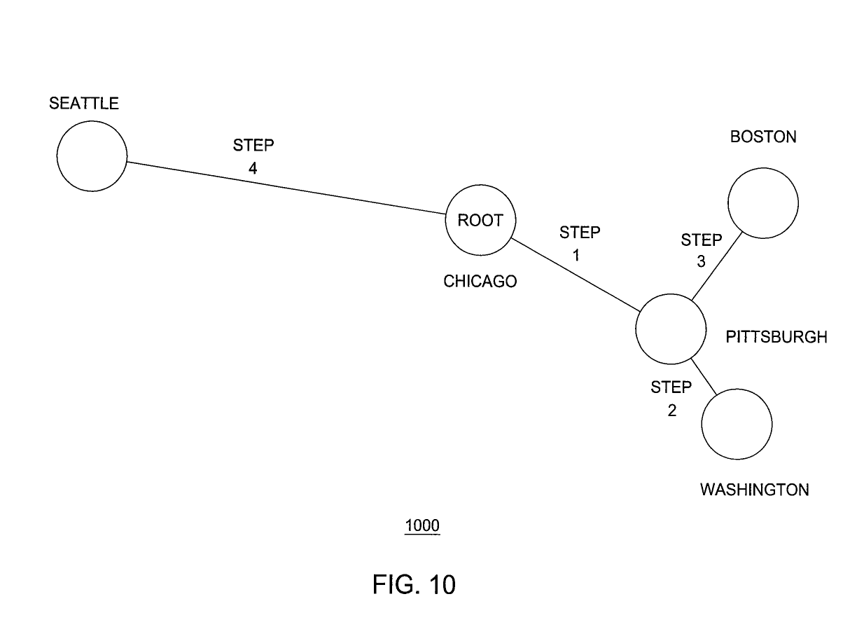

FIG. 10 depicts an example illustrating formation of a media distribution tree by interconnecting regional trees.

As depicted in FIG. 10, five regional trees will be inter-connected to form a media distribution tree 1000. The five regional trees form respective regional networks associated with respective regions. The inter-connecting of regional trees is performed by interconnecting the regional root nodes of the regional trees (omitted for purposes of clarity) to form a backbone tree. In this example, an assumption is made that each of the regions has sufficient ports for inter-region connectivity.

As depicted in FIG. 10, the five regional trees are regional trees for respective regional networks based in the following geographic regions: Chicago, Pittsburgh, Boston, Washington, and Seattle.

In this example, inter-connection of regional trees is performed based on distances between the regions. As depicted in FIG. 10, the network consists of 5 regions: Chicago, Pittsburgh, Boston, Washington, and Seattle. The distances between the regions are summarized in the following table:

| | Pittsburgh | Boston | Washington | Seattle |
|---|---|---|---|---|
| Chicago | 400 | 800 | 600 | 1700 |
| Pittsburgh | | 500 | 200 | 2100 |
| Boston | | | 400 | 2500 |
| Washington | | | | 2300 |

In this example, the Chicago region is pre-selected as the root of the backbone tree, such that, at the beginning of the process, the backbone tree includes the Chicago region. An assumption is made that the maximum allowable depth of the backbone tree is 2. In a first step, among the remaining unattached regions, the region that is closest to the backbone tree (i.e., Chicago) is selected. In this example, Pittsburgh is closest to Chicago. Thus, Pittsburgh is connected to Chicago, forming the new backbone tree.

In a second step, among the remaining unattached regions, the region that is closest to the backbone tree (i.e., Chicago and Pittsburgh) is selected. In this example, Washington is closest to the backbone tree (and, more specifically, is closer to Pittsburgh than to Chicago). Thus, Washington is connected to Pittsburgh, forming the new backbone tree.

In a third step, among the remaining unattached regions, the region that is closest to the backbone tree (i.e., Chicago, Pittsburgh, and Washington) is selected. In this example, although Boston is closer to Washington than Pittsburgh, its closest distance to the backbone tree is to Pittsburgh. This is due to the fact that, if Boston connected to Washington, it will be three hops from Chicago, exceeding the maximum allowable depth. Boston is closer to the backbone tree (distance of 500 to Pittsburgh) than Seattle (distance of 1700 to Chicago). Thus, Boston is connected to Pittsburgh, forming the new backbone tree.

In a fourth step, the remaining unattached region, Seattle, is attached to the backbone tree, thereby finalizing the backbone tree. In this example, Seattle is closer to Chicago than to any of the other regions of the backbone tree and, thus, Seattle is attached to Chicago.

Although primarily depicted and described herein with respect to use of distance between regions to determine the backbone tree, other factors may be used (in addition to or in place of distance) in order to determine the backbone tree. For example, other factors which may be considered in determining the backbone tree include the number of nodes in the respective regions, the number of inter-region connections that can be supported by the respective regions, and the like, as well as various combinations thereof.

As described herein, a regional network is established using a tree topology. The tree topology of a regional tree network includes a regional root node, and may include one or more hierarchical levels below the regional root node. In other words, media content being distributed from a node located near the bottom of a regional tree may have to propagate up through multiple levels of the regional tree before reaching the root of the media distribution tree for distribution to other regions of the media distribution tree. This may add significant delay to propagation of media content throughout the media distribution tree, especially where regional networks include many hierarchical levels. In one embodiment, in order to improve distribution performance for distribution of media content throughout a media distribution tree, one or more bypass connections may be established within the media distribution tree. A bypass connection is a media distribution connection that bypasses one or more levels of the media distribution tree.

In one embodiment, a bypass connection is formed between nodes at different levels of a region.

In one embodiment, a bypass connection is formed between a node of a first region and a node of a second region (e.g., a regional root node of the first region and a regional root node of the second region, or using any other suitable arrangement).

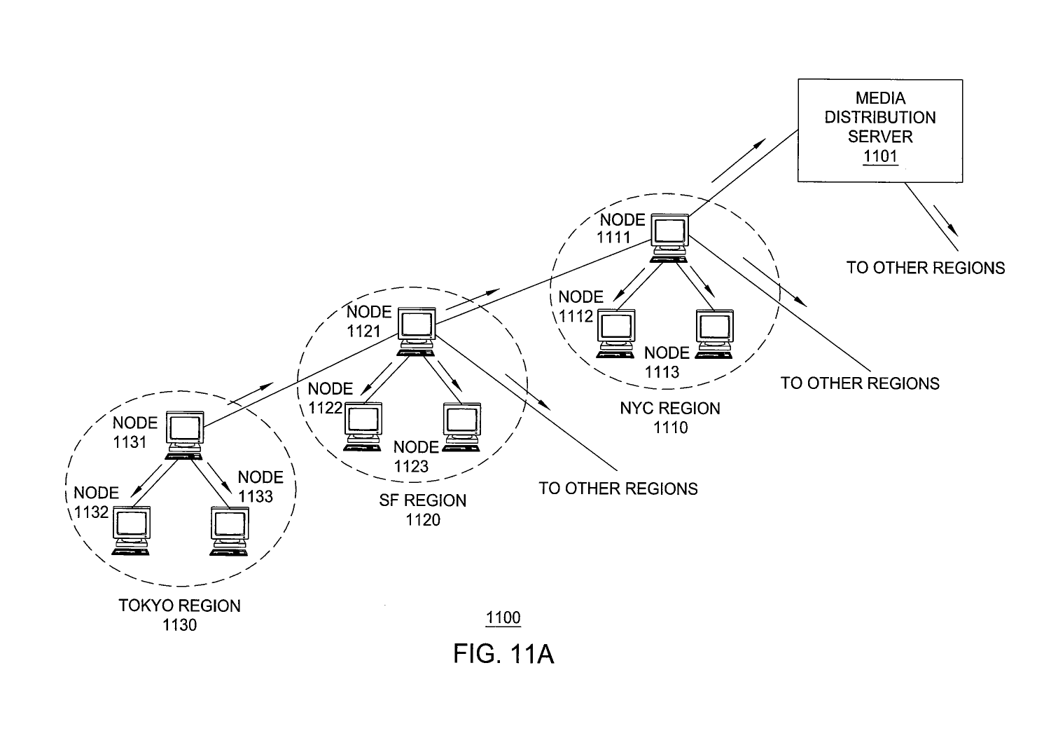

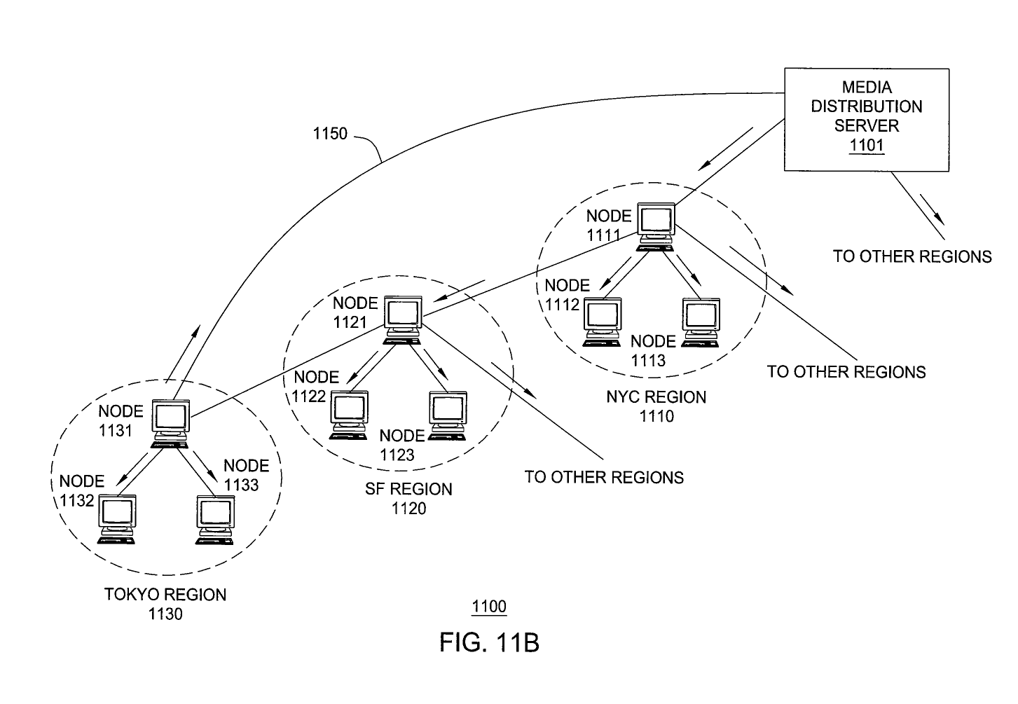

In one embodiment, a bypass connection is formed between a node of a region and the root node of the media distribution tree (e.g., between a regional root node of the region and a media distribution server that is the root of the media distribution tree, or using any other suitable arrangement). An example of such an arrangement using a bypass connection is depicted and described herein with respect to FIG. 11.

FIG. 11A depicts an ‘exemplary portion of a media distribution tree without a bypass connection.

As depicted in FIG. 11, a media distribution tree 1100 is rooted at a media distribution server 1101 located in the New York City area. The media distribution tree 1100 has two or more branches: (1) a first branch connected to a first regional network 1110, and (2) one or more other branches that are omitted for purposes of clarity.

The first regional network 1110 is located in the New York City area. The first regional network 1110 includes a regional root node 1111. The regional root node 1111 is served by media distribution server 1101. The regional root node 1111 serves two other nodes 1122 and 1123 that are located in first regional network 1110, as well as one or more other regions. The first regional network 1110 connects to a second regional network 1120, which is lower than first regional network 1110 in media distribution tree 1100.

The second regional network 1120 is located in the San Francisco area. The second regional network 1120 includes a regional root node 1121. The regional root node 1121 is served by regional root node 1111. The regional root node 1121 serves two other nodes 1122 and 1123 that are located in second regional network 1120, as well as one or more other regions. The second regional network 1120 connects to a third regional network 1130, which is lower than second regional network 1120 in media distribution tree 1100.

The third regional network 1130 is located in the Tokyo area. The third regional network 1130 includes a regional root node 1131. The regional root node 1131 is served by regional root node 1121, and serves two other nodes 1132 and 1133 that are located in third regional network 1130. The third regional network 1130 is positioned at the bottom of the media distribution tree 1100, such that nodes 1132 and 1133 are leaves of media distribution tree 1100.

In the example of FIG. 11A, media content is being distributed from regional root node 1131 to each of the other nodes in the media distribution tree 1100. The regional root node 1131 propagates the media content down to nodes 1132 and 1133 and up to regional root node 1121. The regional root node 1121 then distributes the media content over all of its media ports (i.e., down to nodes 1122 and 1123, as well as to any other regions being served by regional root node 1121, and up to regional root node 1111). The regional root node 1111 propagates the media content in a manner similar to regional root node 1121, including propagating the media content to media distribution server 1101, which then distributes the media content to other branches of the media distribution tree 1100 that are rooted at media distribution server 1101. In this manner, the media content is distributed to all of the nodes of the media distribution tree 1100.

FIG. 11B depicts an exemplary portion of a media distribution tree with a bypass connection. More specifically, FIG. 11B depicts media distribution tree 1110 of FIG. 11A with a bypass connection 1150 provisioned therein. As depicted in FIG. 11B, the bypass connection 1150 is provisioned between regional root node 1131 and media distribution server 1101, thereby enabling media content to bypass the first regional network 1110 and the second regional network 1120.

As described herein, bypass connections may be added to a media distribution tree in order to improve media propagation delay times between nodes of the media distribution tree. Here, the benefits of adding bypass connection 1150 to media distribution tree 1100 are evident from the manner in which addition of bypass connection 1150 changes the propagation of media content within the media distribution tree 1100 (as illustrated by viewing FIG. 11A and FIG. 11B together).

In the example of FIG. 11B, media content is being distributed from regional root node 1131 to each of the other nodes in the media distribution tree 1100. As in FIG. 11A, the regional root node 1131 propagates the media content down to nodes 1132 and 1133 and, rather than propagating the media content up to regional root node 1121, propagates the media content to media distribution server 1101 via bypass connection 1150. The media distribution server 1101 then propagates the media content down to first regional network 1110, as well as to other regional networks rooted at media distribution server (omitted for purposes of clarity). The regional root node then propagates the media content within the first regional network 1110, as well as to any other regional networks that are rooted at regional root node 1111 (including the second regional network 1120). The regional root node 1121 then propagates the media content within the second regional network 1110.

As such, using bypass connection 1150, media distribution server 1101 receives the media content from the regional root node 1131 directly (rather than media distribution server 1101 having to wait for the media content to propagate up from regional root node 1131 to regional root node 1121 to regional root node 1111 before reaching media distribution server 1101), and, thus, can begin propagating the media content to nodes in other branches of the media distribution tree 1100 sooner than would otherwise be possible in the absence of bypass connection 1150. Thus, propagation delay in media distribution tree 1100 is reduced.

Using bypass mode, in which one or more bypass connections are established within a media distribution tree, the maximum delay within the media distribution tree may be reduced from twice the depth of the media distribution tree to the depth of the media distribution tree plus one.

Although primarily depicted and described herein with respect to use of a media distribution tree to distribute content of a single media stream, it will be appreciated that a media distribution tree may be used to distribute content of multiple media streams. For example, a single media distribution tree may be established for distributing audio content via an audio content stream and distributing video content via a video content stream that is separate from the audio content stream. For example, a single media distribution tree may be established for distributing whiteboard content via a whiteboard content stream and distributing video content via a video content stream that is separate from the whiteboard content stream.

Although primarily depicted and described herein with respect to the establishment of a single media distribution tree for a conference, it will be appreciated that multiple media distribution trees may be established for use in distributing different media streams for a conference. For example, a first media distribution tree may be established for distributing audio content for the conference and a second media distribution tree may be established for distributing video content for the conference. For example, a first media distribution tree may be established for distributing whiteboard content for the conference and a second media distribution tree may be established for distributing video content for the conference.

As described herein, the distributed conferencing capability depicted and described herein may be used for establishing a media distribution tree for distribution of content in a conferencing application, as well as in any other application in which content may be distributed using a media distribution tree. Thus, since the establishment of a media distribution tree is primarily depicted and described herein within the context of establishing a media distribution tree for use in a conferencing application, an exemplary conferencing system implementing one embodiment of the distributed conferencing capability is described in additional detail hereinbelow.

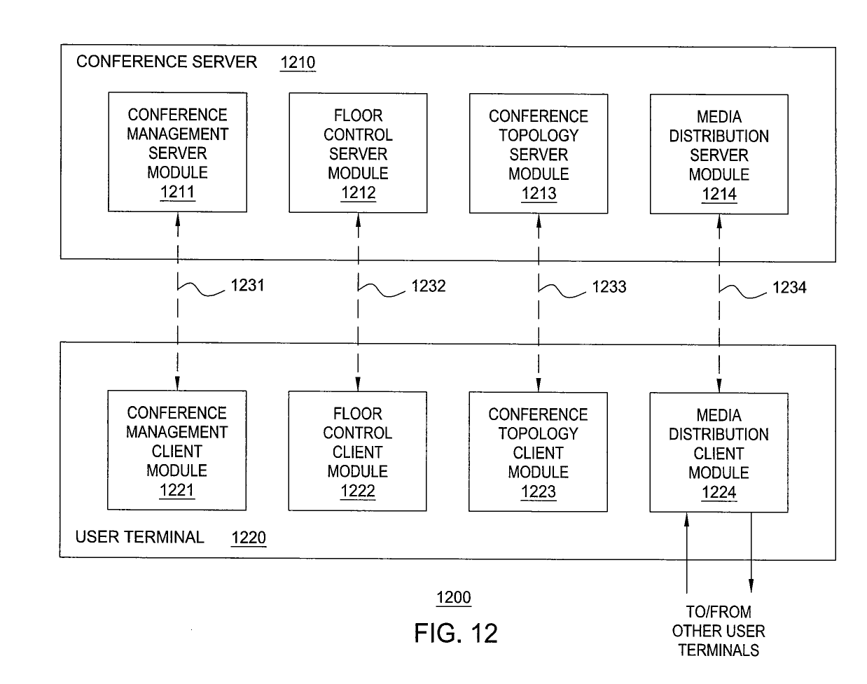

FIG. 12 depicts a high-level block diagram of functional components of an exemplary conferencing system. As depicted in FIG. 12, system 1200 includes a conference server (CS) 1210 and a user device (UD) 1220. It will be appreciated, by those skilled in the art and informed by the teachings herein, that system 1200 will include multiple user devices; however, for purposes of clarity, only one user device is depicted and described in detail with respect to FIG. 12.

The CS 1210 includes a conference management server module (CMSM) 1211, a floor control server module (FCSM) 1212, a conference topology server module (CTSM) 1213, and a media distribution server module (MDSM) 1214. The UD 1220 includes a conference management client module (CMCM) 1221, a floor control client module (FCCM) 1222, a conference topology client module (CTCM) 1223, and a media distribution client module (MDCM) 1224.

The CMSM 1211 and CMCM 1221 are communicatively coupled (as illustrated by logical link 1231) to provide conference management functions for multimedia conferences. The CMSM 1211 and CMCM 1221 exchange control information for providing conference management functions for multimedia conferences. The CMSM 1211 and CMCM 1221 may be referred to collectively herein as conference management modules (CMMs). In one embodiment, the MDMs support a number of higher layer functions, such as allowing users to create and schedule conferences, allowing users to search for conferences (e.g., based on parameters such as conference name, conference creator, conference title, time, and the like), allowing users to invite other users to attend the conference, sending notices and reminders to conference invitees, and the like, as well as various combinations thereof. The MDMs may support other types of functions related to management of a conference.

The FCSM 1212 and FCCM 1222 are communicatively coupled (as illustrated by logical link 1232) to provide floor control functions for multimedia conferences. The FCSM 1212 and FCCM 1222 exchange control information for providing floor control functions for multimedia conferences. The FCSM 1212 and FCCM 1222 may be referred to collectively herein as floor control modules (FCMs).

The CTSM 1213 and CTCM 1223 are communicatively coupled (as illustrated by logical link 1233) to provide conference topology functions for multimedia conferences. The CTSM 1213 and CTCM 1223 exchange control information for providing conference topology functions for multimedia conferences. The CTSM 1213 and CTCM 1223 may be referred to collectively herein as conference topology modules (CTMs). The CTMs may cooperate to enable determination of the topology of a media distribution tree, e.g., using the media distribution tree determination methodologies depicted and described herein. The CTMs may cooperate to exchange the information adapted for use in determining a media distribution tree, and to exchange the configuration information adapted for use in establishing the media distribution tree within the network. The CTMs may cooperate, both which each other as well as with other modules, to provide various other conference topology determination, establishment, and management functions.

The MDSM 1214 and MDCM 1224 are communicatively coupled (as illustrated by logical link 1234) to provide media distribution functions for multimedia conferences. The MDSM 1214 and MDCM 1224 are adapted for participating in exchange of media content (receiving media content and, optionally, distributing media content to other nodes of the conferencing system. The MDSM 1214 and MDCM 1224 may be referred to collectively herein as media distribution modules (MDMs).

The control information exchanged within CS 1200 may be exchanged using any suitable communications capabilities. The media content distributed within CS 1200 may be distributed using any suitable communications capabilities. The communications capabilities may utilize any suitable technologies at any of the associated communications layers.

Although primarily depicted and described herein as separate modules, it will be appreciates that the various modules of CS 1210 and UD 1220 are logical modules for performing associated functions and, thus, that the modules depicted and described herein with respect to CS 1210 may be implemented using any type, number, and/or configuration of physical modules and that the modules depicted and described herein with respect to UD 1220 may be implemented using any type, number, and/or configuration of physical modules.

In one embodiment, following establishment of a conference, one or more media streams may be used for distributing content for the conference. The media streams each may operate in a number of modes, such as floor control mode, mixed mode, and independent mode, among others.

In floor control mode, at most one user is active for that media stream at any given time. The system will provide procedures for floor control in order to arbitrate who should be recognized as the “speaker” for the media stream at any given time. A common implementation for floor control mode is to use a centralized floor-control server with which all users of the conference communicate. When a user wants to be recognized as the “speaker” for the conference, the user sends a request to the floor-control server, which will grant the “floor” (i.e., the right to speak) to only one of the users at a time based on the policy administratively configured at the floor-control server. The users may communicate with the centralized floor-control server using any suitable floor control protocol. An example of one such floor control protocol is the Talk Burst Control Protocol (TBCP), which is the floor control protocol for the Push-to-Talk Over Cellular (PoC) standard from the Open Mobile Alliance (OMA) standard body. Examples of floor control mode include traditional multi-party video conferencing, push-to-talk applications, and the like.

In the mixed mode, all users can send media content at the same time. The media content will be processed and combined in a manner for enabling all of the media content to be distributed to all of the users. The processing, combining, and distribution of the media content for distribution to all of the users may be performed by one or more media servers and/or one or more user devices. An example of mixed mode is regular audio conferencing, where all the participants can speak at the same time. It will be understood that, depending on the application, the combined media streams may be different for different users. As an example, consider an audio conference between four participants (A, B, C, D). In this example, assuming that a media server handles the processing, combining, and distribution of media content, if all participants speak at the same time, the server will sum all of the audio signals from B, C, and D and provide the combined signal to A, sum all of the audio signals A, C, and D and provide the combined signal to B, and so forth. In other words, each of the participants will receive a different media stream from the media server.

In the independent mode, a user will send its media stream to all other users. This can be accomplished in a number of ways. As an example, a user could send its media stream to a centralized server, which will distribute the incoming media stream to the other users. As another example, a user could send the media stream to the other users directly. As another example, if IP packets are used to carry the media stream, all of the users may subscribe to an IP multicast group, and each user will broadcast its media stream to the multicast group.

In any case, it is up to each user device to decide how to handle incoming media streams. As described herein, a user device may receive, process, and present media content in any suitable manner, which may depend on a number of factors, such as the type of media content received, capabilities of the receiving user device, preferences of the user at the user device, and the like, as well as various combinations thereof. As an example, if a user device receives a whiteboard stream and a video stream, the user device may present the whiteboard content and video content using a split screen capability, picture-in-picture, or any other suitable presentation method. As another example, if a user device receives multiple video streams, the user device receiving the video streams can display one of the video streams in high quality while displaying the remaining video streams in low quality.

As described herein, a conference may have more than one media stream active at the same time. In one embodiment, the multiple media streams active for a conference may operate in different modes. As an example, consider whiteboard conferencing. In whiteboard conferencing, the data stream usually operates in floor-control mode so that only one user can write on the whiteboard at a time (to avoid confusion), while the audio stream usually operates in mixed mode so that all users of the conference can speak at any time.

The distributed conference capability depicted and described herein may be used in conjunction with any conference management logic/protocols, any floor control logic/protocols, and/or by media distribution logic/protocols.

Although conferencing system 1200 of FIG. 12 is primarily depicted and described with respect to a specific embodiment in which each of the functional modules are resident on a single media server, it will be appreciated that the functional modules may be implemented within a media server in a different manner than depicted and described with respect to FIG. 12, may be distributed across multiple media servers and/or other network elements, and the like, as well as various combinations thereof. The implementation of the distributed conferencing capability in a conferencing system is not intended to be limited to the exemplary embodiment depicted and described herein with respect to FIG. 12.

It will be appreciated that other types of systems may be implemented utilizing various embodiments of the distributed conferencing capability.

The distributed conferencing capability depicted and described herein provides many advantages, such as enabling a reduction in the number of ports required at the media distribution server(s) to support the conference (which thereby reduces equipment costs required to support conferences), enabling automatic configuration and establishment of media distribution trees based at least in part on geographic locations and device capabilities of the participants of the conference, and enabling reductions in overall bandwidth utilization required to support the conference, among other advantages which are described herein.

As noted hereinabove, although primarily depicted and described herein with respect to establishing a media distribution tree for distributing content during a conference, it will be appreciated by those skilled in the art and informed by the teachings herein that the distributed conferencing capability depicted and described herein may be used to establish a media distribution tree for applications other than conferencing applications (e.g., for use in content distribution applications, content sharing applications, or any other applications for which a media distribution tree may be used to distribute content). It will be appreciated that the media distribution tree also may be referred to as a content distribution tree or, more generally, as a distribution tree, in that other types of information may be distributed using such a distribution tree.

As noted hereinabove, although primarily depicted and described herein with respect to specific functions, operations, and/or steps, many of the functions, operations, and/or steps that are depicted and described herein are examples and, thus, those skilled in the art can readily devise other varied embodiments that still incorporate these teachings. For example, steps may be performed in a different order, different tiebreaking rules may be used in tiebreaking situations, fewer or more parameters may be used to determine media distribution trees, and the like, as well as various combinations thereof.

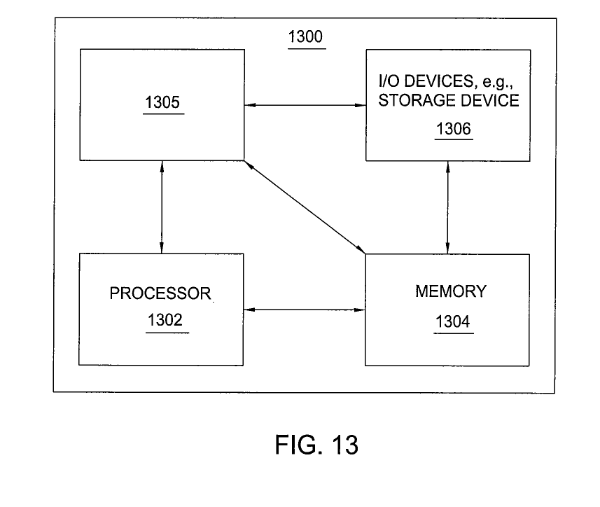

FIG. 13 depicts a high-level block diagram of a general-purpose computer suitable for use in performing the functions described herein. As depicted in FIG. 13, system 1300 comprises a processor element 1302 (e.g., a CPU), a memory 1304, e.g., random access memory (RAM) and/or read only memory (ROM), a media distribution tree control module 1305, and various input/output devices 1306 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, media distribution tree control process 1305 can be loaded into memory 1304 and executed by processor 1302 to implement the functions as discussed above. As such, the media distribution tree control process 1305 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for determining a media distribution tree for use in distributing content to a plurality of user devices, comprising:
grouping the user devices into a plurality of regions;
determining, for each of the regions, a regional tree to be formed by the user devices grouped into the region; and
connecting the regional trees to determine thereby the media distribution tree.

2. The method of claim 1, wherein the user devices are grouped into regions using location information associated with the user devices.

3. The method of claim 1, wherein at least a portion of the user devices are grouped into regions based at least on geographic locations of the user devices.

4. The method of claim 1, wherein at least a portion of the user devices are grouped into regions based on geographic locations of the user devices and network locations of the user devices.

5. The method of claim 1, wherein, for at least one of the regions, the regional tree is determined using device capability information associated with the respective user devices grouped into the region.

6. The method of claim 5, wherein, for each user device, the device capability information comprises information indicative of a number of media streams that the user device is capable of replicating and distributing.

7. The method of claim 1, wherein, for at least one of the regions, the regional tree is determined in a manner for increasing a width of the regional tree and decreasing a depth of the regional tree.

8. The method of claim 1, wherein, for at least one of the regions, determining the regional tree comprises:
selecting one of the nodes grouped into the region; and
determining the position of the selected node within the regional tree by placing the node into the regional tree such that the following conditions are satisfied:
(a) all of the nodes of the regional tree between the selected node and a regional root node of the regional tree have an associated order equal to or greater than an order of the selected node, wherein the order of a node is indicative of a number of intra-region media streams that the selected node is capable of replicating and distributing;
(b) the selected node is closest to the regional root node while satisfying (a);
(c) a maximum allowable depth of the regional tree is not exceeded; and
wherein, if any of conditions (a), (b), or (c) cannot be satisfied, a new region is created for the selected node.

9. The method of claim 1, wherein, for at least one of the regions, determining the regional tree comprises:
selecting one of the nodes grouped into the region; and
determining a position of the selected node within the regional tree based on an order of the selected node, wherein the order of the selected node is indicative of a number of intra-region media streams that the selected node is capable of replicating and distributing.

10. The method of claim 9, wherein, if the order of the selected node is zero, determining the position of the selected node within the regional tree based on the order of the selected node comprises:
determining if any unused ports are available in the regional tree;
if unused ports are not available in the regional tree, creating a new region for the selected node;
if unused ports are available in the regional tree:
identifying nodes in the regional tree having at least one unused port;
selecting one of the identified nodes at the highest level of the regional tree; and
updating the regional tree by attaching the selected node as a child of the selected one of the identified nodes.

11. The method of claim 9, wherein, if the order of the selected node is greater than zero, determining the position of the selected node within the regional tree based on the order of the selected node comprises:
determining whether the regional root node of the regional tree has an associated order that is less than, equal to, or greater than the order of the selected node;
if the regional root node of the regional tree has an associated order that is less than the order of the selected node, updating the regional tree by making the selected node the regional root node of the regional tree and attaching the previous regional root node as a child of the selected node;
if the regional root node of the regional tree has an associated order that is equal to or greater than the order of the selected node, determining whether to update the regional tree to include the selected node or to create a new region for the selected node, wherein the determination as to whether to update the regional tree to include the selected node or to create a new region for the selected node is based on at least one of: a number of unused ports associated with nodes of the regional tree and a regional tree depth threshold of the regional tree.

12. The method of claim 1, wherein connecting the regional trees comprises:
interconnecting a plurality of regional root nodes of the respective regions.

13. The method of claim 12, wherein the regional root nodes are inter-connected subject to a hop count limit requiring each regional root node to be within a threshold number of hops from a root of the media distribution tree.

14. The method of claim 12, wherein at least a portion of the regional root nodes are interconnected via at least one media server.

15. The method of claim 1, wherein connecting the regional trees comprises:
(a) initializing a backbone tree;
(b) for each unattached region, determining a distance of the unattached region to the backbone tree;
(c) selecting one of the unattached regions having a shortest distance to the backbone tree;
(d) attaching the selected one of the unattached regions to the backbone tree; and
(e) repeating steps (b)-(d) until all regions are attached to the backbone tree.

16. The method of claim 1, further comprising:
updating the media distribution tree to include a bypass connection from a regional node of one of the regions to a root node of the media distribution tree.

17. The method of claim 1, wherein the regional trees are determined using a first set of criteria and the regional trees are connected using a second set of criteria.

18. The method of claim 17, wherein:
determining the regional trees using the first set of criteria comprises determining each of the regional trees in a manner tending to reduce the depth of the regional trees and increase the width of the regional trees; and
connecting the regional trees using the second set of criteria comprises connecting the regional trees to form a backbone tree in a manner tending to minimize a distance of each of the regional trees to the backbone tree.

19. The method of claim 1, further comprising:
determining media distribution tree connectivity information based on the determined media distribution tree; and
propagating the media distribution tree connectivity information toward at least a portion of the user devices for use by the user devices in establishing the media distribution tree.

20. An apparatus for determining a media distribution tree for use in distributing content to a plurality of user devices, comprising:
means for grouping the user devices into a plurality of regions;
means for determining, for each of the regions, a regional tree to be formed by the user devices grouped into the region; and
means for connecting the regional trees to determine thereby the media distribution tree.

21. A computer readable medium storing a software program which, when executed by a computer, cause the computer to perform a method for determining a media distribution tree for use in distributing content to a plurality of user devices, the method comprising:
grouping the user devices into a plurality of regions;
determining, for each of the regions, a regional tree to be formed by the user devices grouped into the region; and
connecting the regional trees to determine thereby the media distribution tree.
